(19) United States
(12) Patent Application Publication
(10) Pub. No.: US 2026/0368071 A1
(43) Pub. Date: Nov. 19, 2026

(54) PREFERENCE ALIGNMENT TRAINING FOR UNIT TEST GENERATION

(71) Applicant: Oracle International Corporation, Redwood Shores, CA (US)

(72) Inventors: Thanh Tien Vu, Herston (AU); Duc Thien Nguyen, Melbourne (AU); Dai Quoc Nguyen, Raceview (AU); Omid Mohamad Nezami, Sydney (AU); Prashan Madumal, Melbourne (AU); Yakupitiyage Don Thanuja Samodhye Dharmasiri, Melbourne (AU); Cong Duy Vu Hoang, Wantirna (AU); Meng Chen, Melbourne (AU); Mohammad Mahdi Kazemi Moghaddam, Sydney (AU); Philip Arthur, Sydney (AU); Duy Vu, Melbourne (AU); Gioacchino Tangari, Sydney (AU); Thanh Long Duong, Melbourne (AU)

(73) Assignee: Oracle International Corporation, Redwood Shores, CA (US)

(21) Appl. No.: 19/209,419

(22) Filed: May 15, 2025

(51) Int. Cl. G06F 11/3668; G06F 8/10

(52) U.S. Cl. CPC G06F 11/3684; G06F 8/10

(57) ABSTRACT

Techniques are disclosed herein for a preference alignment training framework with a data synthesis approach for enhancing the performance of generative models in generating unit tests by enabling the generative model to cover more edge and corner cases. In one aspect, a method is disclosed that includes accessing example pairs comprising code examples and results associated with performance of a code task on corresponding code examples, generating, by a generative model, a specification and edge and corner case definitions for each of the example pairs, generating, by a generative model, a set of preference alignment training examples comprises versions of results associated with the code examples based on the example pairs and the specification for each of the example pairs, and fine-tuning a machine learning model with the set of preference alignment training examples.

### FIELD

The present disclosure relates generally to Artificial Intelligence (AI)-assisted development tools, and more particularly, to a preference alignment training framework with a data synthesis approach for enhancing the performance of generative models such as large language models (LLMs) in generating unit tests by enabling the LLMs to cover more edge and corner cases.

### BACKGROUND

LLM-based coding assistants are advanced software tools that utilize LLMs to assist developers in writing, editing, and understanding code. These assistants leverage the capabilities of models like OpenAI's GPT series, Code Llama, and other specialized LLMs trained on vast datasets of source code and technical documentation. By analyzing the context of a developer's current work, such as the structure of existing code, comments, and coding patterns, these tools can provide real-time suggestions for code completions, generate new code snippets, and even offer explanations for complex code logic. Their primary goal is to enhance productivity, reduce errors, and streamline the coding process by acting as an AI-powered pair programmer.

One of the core functionalities of LLM-based coding assistants is their ability to understand and adapt to different programming languages and frameworks. They are trained on multilingual code repositories, including open-source platforms like GitHub, allowing them to recognize syntax, libraries, and best practices across languages such as Python, Java, JavaScript, C++, and more. Additionally, these tools integrate into popular integrated development environments (IDEs) like Visual Studio Code, IntelliJ IDEA, and PyCharm, providing seamless support directly within the developer's workspace. By understanding the broader context of a project, such as its dependencies and architecture, LLM-based coding assistants can suggest solutions tailored to the specific needs of the codebase.

Beyond code generation and completion, these assistants offer several other features that boost their utility. They can debug code by identifying syntax errors, logic flaws, or runtime issues and suggest fixes in real-time. Many also provide natural language explanations for code, making them invaluable for developers learning a new language or framework. Advanced tools can even generate tests, documentation, or boilerplate code, significantly reducing the time developers spend on repetitive tasks. In addition, some LLM-based coding assistants are capable of handling queries written in plain language, enabling developers to ask questions like “How do I implement a binary search in Python?” and receive precise, context-aware responses.

The rise of LLM-based coding assistants represents a transformative shift in the software development landscape. By automating routine coding tasks and providing intelligent suggestions, these tools allow developers to focus on higher-level problem-solving and innovation. However, they also raise new challenges, such as ensuring the accuracy and quality the code suggestions, completions, and generation capabilities. Despite these challenges, the adoption of LLM-based coding assistants is rapidly growing, with tools like GitHub Copilot, Code Llama, and other similar tools, making coding more accessible, efficient, and collaborative for developers of all experience levels.

### BRIEF SUMMARY

Machine learning techniques are disclosed herein (e.g., a computer implemented method, a system, non-transitory computer-readable medium storing code or instructions executable by one or more processors) for data synthesis approach that can be used to enhance the performance of generative models such as LLMs in generating unit tests by enabling the LLMs to cover more edge and corner cases. The techniques focus on creating preference pairs (e.g., chosen and rejected examples) by applying changes that improve clarity and accuracy. By making targeted revisions, the optimization process is simplified resulting in a significantly improved generative model.

In some embodiments, a computer-implemented method includes accessing example pairs comprising code examples and results associated with performance of a code task on corresponding code examples; generating, by a first generative model, a specification and edge and corner case definitions for each of the example pairs based on the code examples and the results associated with the code examples, wherein the specification is a response or document outlining requirements and parameters needed to perform the code task, and the edge and corner case definitions include requirements for performance of the code task in scenarios that occur outside a normal or expected range of inputs, outputs, or behaviors of the code examples; generating, by a second generative model, a set of preference alignment training examples based on the example pairs and the specification and the edge and corner case definitions for each of the example pairs, wherein each of the training examples in the set of preference alignment training examples comprises a version of a result associated with a code example; and fine-tuning a pre-trained machine learning model with the set of preference alignment training examples to generate a fine-tuned machine learning model.

In some embodiments, the computer-implemented method further comprises, prior to fine-tuning the pre-trained machine learning model, filtering the set of preference alignment training examples to generate a set of filtered preference alignment training examples, wherein the filtering comprises: performing generative model judge-based filtering on the set of preference alignment training examples, wherein the generative model judge-based filtering comprises evaluating, using a generative model, quality of each of the training examples in the set of preference alignment training examples and removing training examples from the set of preference alignment training examples based on the evaluating, performing rule-based filtering on the set of preference alignment training examples, wherein the rule-based filtering comprises evaluating, using filtering heuristics, quality of each of the training examples in the set of preference alignment training examples and removing training examples from the set of preference alignment training examples based on the evaluating, or performing both the generative model judge-based filtering and the rule-based filtering, wherein the set of filtered preference alignment training examples is used for fine-tuning the pre-trained machine learning model as an alternative to fine-tuning using the set of preference alignment training examples.

In some embodiments, generating the set of preference alignment training examples is an iterative process that comprises: generating, based on an example pair from the example pairs and the specification and the edge and corner case definitions for the example pair, a training prompt comprising instructions requesting the second generative model to perform the code task using a code example from the example pair and insight derived from: (i) a result from the example pair and associated with the code example, and (ii) the specification and the edge and corner case definitions for the example pair, generating, by the second generative model based on the training prompt, a training completion, which is a response expected from executing the code task using the code example, and associating the training prompt with the training completion and the result from the example pair to generate a preference alignment training example of the set of preference alignment training examples.

In some embodiments, the results are unit tests, the code task is a task for generating a unit test for given a code example, and a version of a result is a version of a unit test.

In some embodiments, generating the set of preference alignment training examples comprises generating, based on an example pair from the example pairs and the specification and the edge and corner case definitions for the example pair, a training prompt comprising instructions requesting the second generative model to perform the code task using a code example from the example pair and insight derived from: (i) a result from the example pair and associated with the code example, and (ii) the specification and the edge and corner case definitions for the example pair, and the training prompt is input into the second generative model to generate a training completion, which is a portion of a preference alignment training example of the set of preference alignment training examples.

In some embodiments, the computer-implemented method further comprises, prior to fine-tuning the pre-trained machine learning model, filtering the set of preference alignment training examples to generate a set of filtered preference alignment training examples, wherein the filtering comprises: performing generative model judge-based filtering on the set of preference alignment training examples, wherein the generative model judge-based filtering comprises: evaluating, using a generative model, quality of each of the training examples in the set of preference alignment training examples, and evaluating, using the generative model, quality of each of the results associated with performance of the code task on corresponding code examples; performing rule-based filtering on the set of preference alignment training examples, wherein the rule-based filtering comprises evaluating, using filtering heuristics, quality of each of the training examples in the set of preference alignment training examples; and removing training examples from the set of preference alignment training examples based on: (i) the evaluating, by the generative model judge-based filtering, the quality of each of the training examples and the each of the results, (ii) the evaluating, by the rule-based filtering, the quality of each of the training examples, or (iii) both, wherein the set of filtered preference alignment training examples is used for fine-tuning the pre-trained machine learning model as an alternative to fine-tuning using the set of preference alignment training examples.

In some embodiments, the computer-implemented method further comprises: receiving an input from a user, the input comprising a natural language component; converting the input into a prompt, wherein the prompt comprises an instruction, a code snippet associated with the natural language component, and an utterance associated with the natural language component, and wherein the utterance includes a request to perform the code task; transmitting the prompt to the fine-tuned machine learning model; receiving, from the fine-tuned machine learning model, a response corresponding to execution of the code task based at least in part on the prompt; and providing the response to the user.

Some embodiments include a system that includes one or more processors; and one or more computer-readable media storing instructions which, when executed by the one or more processors, cause the system to perform part or all of the operations and/or methods disclosed herein.

Some embodiments include one or more non-transitory computer-readable media storing instructions which, when executed by one or more processors, cause a system to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

The present disclosure will be better understood in view of the following non-limiting figures, in which:

FIG. 1 depicts a simplified diagram for an example code tool, according to various embodiments.

FIG. 2 depicts a simplified diagram for an example generative AI code agent system, according to various embodiments.

FIG. 3 depicts a simplified diagram for an example generative AI code agent, according to various embodiments.

FIG. 4 depicts a simplified block diagram for training, testing, and producing a code model, according to various embodiments.

FIG. 5 depicts a simplified block diagram for a preference alignment training framework, according to various embodiments.

FIG. 6 is a flowchart illustrating a process for generating a fine-tuning dataset including synthetic training examples to fine-tune a machine learning model for one or more code tasks, according to various embodiments.

FIG. 7 is a block diagram illustrating one pattern for implementing a cloud infrastructure as a service system, according to various embodiments.

FIG. 8 is a block diagram illustrating another pattern for implementing a cloud infrastructure as a service system, according to various embodiments.

FIG. 9 is a block diagram illustrating another pattern for implementing a cloud infrastructure as a service system, according to various embodiments.

FIG. 10 is a block diagram illustrating another pattern for implementing a cloud infrastructure as a service system, according to various embodiments.

FIG. 11 is a block diagram illustrating an example computer system, according to various embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### INTRODUCTION

The present disclosure relates to systems and methods for assisting software developers in code generation, completion, explanation, documentation or unit test generation through the use of advanced artificial intelligence technologies, specifically generative models such as large language models (LLMs). Generative AI-based coding assistants represent a significant advancement in the field of software development, providing developers with real-time support by generating context-aware code suggestions, completions, and explanations. These tools leverage the capabilities of machine learning models trained on extensive datasets of source code, programming documentation, and technical resources to act as intelligent, AI-powered pair programmers. By analyzing the context of a developer's current work, such as the structure of existing code, comments, and programming patterns, such systems aim to enhance productivity, reduce errors, improve accuracy, and streamline the software development process.

Traditional code editing tools and integrated development environments (IDEs) offer limited support for code completion and debugging, relying on predefined rules and syntax libraries. In contrast, generative AI-based coding assistants are dynamic and adaptive, capable of understanding and generating code across multiple programming languages and frameworks. These systems are conventionally trained on multilingual repositories, including open-source codebases, enabling them to provide comprehensive support for programming languages such as Python, Java, JavaScript, C++, and others. Furthermore, their integration into popular IDEs, such as Visual Studio Code, IntelliJ IDEA, and PyCharm, allows them to operate within the developer's workflow, providing intelligent recommendations based on the broader context of a project, including its dependencies, architecture, and coding standards.

Despite their numerous advantages, the integration of generative AI-based coding assistants into the software development process raises important considerations, including ensuring the quality and accuracy of the generated code. However, improving and optimizing the accuracy of generative models, such as LLMs, in assisting software developers presents several challenges. One major challenge is ensuring the quality and correctness of the code generated, as even small inaccuracies in syntax or logic can lead to errors or vulnerabilities in the software. LLMs often rely on vast datasets of publicly available code, which may include outdated, inefficient, or insecure coding practices, making it difficult to guarantee consistent, high-quality outputs. Additionally, understanding the nuanced context of a developer's codebase-such as project-specific architecture, dependencies, or coding standards-requires fine-tuning the model to handle diverse and complex scenarios effectively. Another challenge lies in balancing the model's computational efficiency with its accuracy, as larger models with higher capabilities often require significant processing power, which can limit their practicality for real-time use in IDEs. Furthermore, addressing intellectual property concerns and ensuring compliance with open-source licensing when training models on publicly available code repositories adds another layer of complexity. These challenges collectively highlight the need for continuous innovation in model training, fine-tuning, and validation to ensure generative AI-based coding assistants can provide reliable, accurate, and contextually appropriate assistance to developers.

To enhance the focus and performance of generic base LLMs specifically for unit test generation from code snippets such as Java code snippets, one step is supervised finetuning (SFT) using instruction data curated for the task. While this SFT step improves model performance, further enhancements are needed, particularly in handling edge cases and improving code readability. In the SFT process, only positive data may be utilized, where each data point has an input prompt comprised of an instruction and a unit test solution. However, even with identical input prompts, there are multiple approaches to writing unit tests for a given code snippet. To address this challenge and others, the techniques described herein implement preference alignment training (PAT) to further enhance the model. Unlike SFT, each data point in PAT includes the input prompt, a chosen unit test solution, and a rejected unit test (negative data). The chosen unit test solution effectively answers the input prompt, while the rejected unit test fails to do so. Training with this data allows the model to generate more precise and accurate unit tests that closely resemble the chosen output, while minimizing the risk of generating incomplete solutions similar to the rejected unit test. Employing PAT alongside SFT is an effective approach in LLM development; for instance, LLaMA-3 model achieved a 10% absolute improvement with 10 million data points through SFT+PAT.

The disclosed embodiments seek to overcome these challenges and build upon these advancements by introducing techniques that further enhance the capabilities, efficiency, and accuracy of generative AI-based coding models and assistants, addressing the limitations of existing tools and providing improved functionality to meet the evolving needs of software developers. More specifically, disclosed herein is a framework for PAT to enhance unit test generation capabilities. Although PAT has proven beneficial and is an important step in LLM development, the manual curation of data for PAT is often costly and time-consuming, requiring annotators with coding expertise. These challenges are addressed by introducing a pipeline to automate and optimize the preference data curation process. The objective is not only to automate the generation of preference data but also to enhance the effectiveness of preference optimization by optimizing data automation operations focusing on targeted synthesis, resulting in significant improvements. The framework also minimizes the need for large-scale data synthesis with larger models, thus speeding up the overall data generation process. Lastly, this framework can be easily extended to other coding tasks such as code. documentation, code explanation, and code generation.

The framework involves three main phases:
1. Specification and Edge/Corner Case Definition Generation: Using advanced generative models such as Cohere Command-R, detailed specifications and definitions for edge and corner cases are generated.
2. LLM-based Data Synthesis: Utilize a base generative model (e.g., Qwen2-72B-Instruct or Meta-Llama-3-70B-Instruct) to synthesize data by leveraging in-context learning with examples from a small set of high-quality data, e.g., human-generated data.
3. Construct Preference Pairs and Perform Preference Optimization: This step involves creating “chosen” and “rejected” examples. The chosen example is the synthesized data from Step 2, while the rejected example is the original data before synthesis. Preference optimization algorithms (such as Direct Preference Optimization (DPO)) are then applied to enhance the base model's performance.

The curated data is subsequently utilized in a PAT training pipeline to further optimize SFT base models for generating more accurate unit tests with greater coverage of edge cases. Quantitative and qualitative results show that the data synthesis approach, combined with optimization algorithms such as DPO, outperforms other methods, delivering significantly better performance. More specifically, experiments demonstrate that the newly synthesized data can achieve significant improvements with a win/tie rate of 77% over the base supervised fine-tuned (SFTed) LLM on unit test generation tasks and a pass rate of 81% compared to 74% for the SFTed LLM. Qualitative analysis further confirms targeted improvements, leading to a higher number of passing solutions on different coding problems from public benchmarks.

In an exemplary embodiment, a computer-implemented method is provided for that includes accessing example pairs comprising code examples and results associated with performance of a code task on corresponding code examples; generating, by a first generative model, a specification and edge and corner case definitions for each of the example pairs based on the code examples and the results associated with the code examples, wherein the specification is a response or document outlining requirements and parameters needed to perform the code task, and the edge and corner case definitions include requirements for performance of the code task in scenarios that occur outside a normal or expected range of inputs, outputs, or behaviors of the code examples; generating, by a second generative model, a set of preference alignment training examples based on the example pairs and the specification and the edge and corner case definitions for each of the example pairs, wherein each of the training examples in the set of preference alignment training examples comprises a version of a result associated with a code example; and fine-tuning a pre-trained machine learning model with the set of preference alignment training examples to generate a fine-tuned machine learning model.

As used herein, the terms “about,” “similarly,” “substantially,” and “approximately” are defined as being largely but not necessarily wholly what is specified (and include wholly what is specified) as understood by one of ordinary skill in the art. In any disclosed embodiment, the term “about,” “similarly,” “substantially,” or “approximately” may be substituted with “within [a percentage] of” what is specified, where the percentage includes 0.1 percent, 1 percent, 5 percent, and 10 percent, etc.

As used herein, when an action is “based on” something, this means the action is based at least in part on at least a part of the something.

### Overview of Agents and Code Assistant Framework

An agent (also referred to as a skill, chatbot, chatterbot, talkbot, digital assistant, or the like) is a computer program that can perform conversations with end users. The agent can generally respond to natural-language messages (e.g., questions or comments) through a messaging application that uses natural-language messages. Enterprises may use one or more agent systems to communicate with end users through a messaging application. The messaging application, which may be referred to as a channel, may be an end user preferred messaging application that the end user has already installed and familiar with. Thus, the end user does not need to download and install new applications in order to chat with the agent system. The messaging application may include, for example, over-the-top (OTT) messaging channels (such as Facebook Messenger, Facebook WhatsApp, WeChat, Line, Kik, Telegram, Talk, Skype, Slack, or SMS), virtual private assistants (such as Amazon Dot, Echo, or Show, Google Home, Apple HomePod, etc.), mobile and web app extensions that extend native or hybrid/responsive mobile apps or web applications with chat capabilities, or voice based input (such as devices or apps with interfaces that use Siri, Cortana, Google Voice, or other speech input for interaction).

End users may interact with the agent system through a conversational interaction (sometimes referred to as a conversational user interface (UI)), just as interactions between people. In some cases, the interaction may include the end user providing an utterance such as request: “Explain the purpose of this code snippet”, to the agent, and the agent responding with a natural language response to the utterance based on processing of a prompt including the user's natural language utterance.

In some embodiments, the agent system may intelligently handle end user interactions without interaction with an administrator or developer of the agent system. For example, an end user may send one or more messages to the agent system in order to achieve a desired goal. A message may include certain content, such as natural language text, audio, image, video, or other method of conveying a message. In some embodiments, the agent system may process by executing a code task such as code generation, completion, explanation, documentation or unit test generation. The agent system may also prompt the end user for additional input parameters or request other additional information. In some embodiments, the agent system may also initiate communication with the end user, rather than passively responding to end user utterances. Described herein are various techniques for identifying an explicit or implicit invocation of an agent system and determining an input for the agent system being invoked.

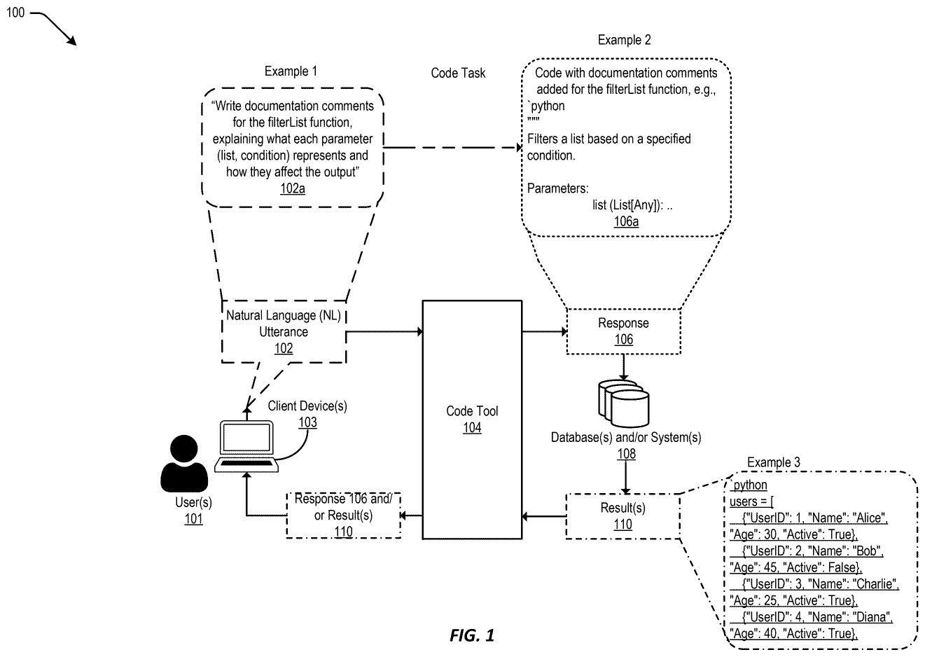

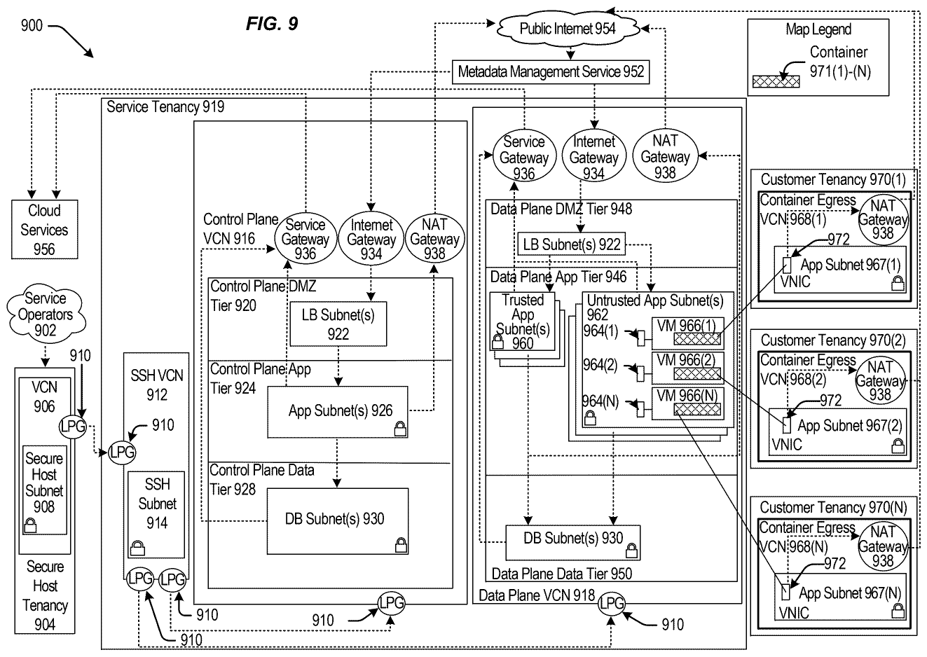

FIG. 1 depicts a simplified diagram of an environment 100 incorporating an exemplary code tool, according to various embodiments. Environment 100 includes a code tool 104 that enables users 101 to send a response 102 (e.g., a request for code generation, completion, explanation, etc.), receive a response 106 (e.g., unit test code, code with documentation added, code review summary, detailed explanation of the code in natural language, and the like) and/or a result 110 of executing code related to a response 106 (e.g., a unit test code, which is then executed on test or production system). As shown in FIG. 1, the code tool 104 is configured to generate a response 106 and/or one or more result(s) 110 based on the provided natural language utterance 102, however other examples may implement tasks in addition to or alternative to code tasks (e.g., codebase checking, extraction of key information, and other codebase related tasks). The code tool 104 can be implemented using software only, hardware only, firmware only, or any combination of hardware, software, and/or firmware. In some instances, the environment 100 is part of an Infrastructure as a Service (IaaS) cloud service (described in more detail with respect to FIGS. 9-13) and the code tool can be implemented as part of the IaaS by leveraging the scalable computing resources and storage capabilities provided by the IaaS provider to process and manage large volumes of data and complex computations. This setup can allow the code tool 104 to deliver real-time, responsive interactions while ensure high availability, security, and performance scalability to meet varying demand levels. The code tool 104 can be embodied or implemented in various physical systems or devices, such as in a computer, a mobile phone, a watch, an appliance, a vehicle, and the like. For the purposes of examples herein, the code tool 104 generates and accepts utterances related to Java code, but it should be understood that the techniques described herein are not limited to Java and the code tool 104 can be configured as any other code tool capable of generating response and/or results using other programming languages (e.g., SQL, Ruby, WebAssembly, Python, R, C++, N1QL, and the like).

As illustrated in FIG. 1, a user 101 provides a user input to the NL2SQL tool 104. The user input can be or can include a natural language utterance 102. The natural language utterance can be in text form, such as when the user types a sentence, a question, a text fragment, or phrase and provides it as an input to the code tool 104 via client device(s) 103. The client devices(s) 103 can be configured to communicate with the code tool 104, provide the natural language utterance 102 to the code tool 104 and receive outputs from the code tool 104. In some implementations, the natural language utterance 102 can be in speech form, which may be converted to text form and provided to the code tool 104. As an example, a natural language utterance 102 such as 102a “Write documentation comments for the filterList function, explaining what each parameter (list, condition) represents and how they affect the output” can be spoken by the user 101 and the code tool 104 may be configured as a standalone or via a plug-in, or make use of some other audio-to-text translator, configured to translate the audio into text for further processing.

The code tool 104 may be or may make use of one or more generative artificial intelligence models such as LLMs configured to generate a natural language response 106 (e.g., 106a) based on the natural language utterance 102. The code tool 104 may receive a prompt including the natural language utterance 102 to generate a response 106 that it is relevant to the user 101 preferences. In some implementations, the user 101 and/or client device 103 generate a prompt including the natural language utterance 102 before providing the prompt to the code tool 104. In other implementations, the code tool 104 receives the natural language utterance 102 and generates the prompt itself, e.g., populates slots of a prompt template, before providing the prompt to a trained generative artificial intelligence model.

The code tool 104 executes a code task and responds to the natural language utterance 102 (as in example 1 depicted in FIG. 1). The code tool 104 may consider code (e.g., a code snippet in the prompt or code retrieved from within a codebase) to generate the response 106. In some implementations, the response 106 is provided to the user(s) in addition to or without running the piece of code (e.g., code snippet) on the database(s) and/or system(s) 108. Additionally or alternatively, the code tool 104 may provide the response 106 to the user(s) via some other means such as an email communication, SMS message, or other type of notification receivable on one or more other computing devices. In some implementations, the response 106 (as in examples 2 depicted in FIG. 1) may be executed on database(s) and/or system(s) 108 to obtain a result 110. As a non-limiting example, a result 110 can be a filtered list of students above the age of 18 based on a received or generated piece of code (e.g., code snippet). The result(s) 110 can be provided back to the user 101 by the code tool 104. In some instances, the result(s) 110 are reported back to the user 101 as raw output. In other instances, the result(s) 110 are reported back to the user 101 as part of the natural language response (e.g., a summary) generated by the one or more generative artificial intelligence models in response to the natural language utterance 102. In other instances, the result(s) 110 are reported back to the user 101 as part of a natural language response (e.g., a summary) generated by the one or more generative artificial intelligence models and/or with a visualization (e.g., a bar chart, pie chart, table, or the like) generated by one or more generative artificial intelligence models and/or analytic subsystems in response to the natural language utterance 102. The user 101 may receive the result(s) 110 through the client device(s) 103.

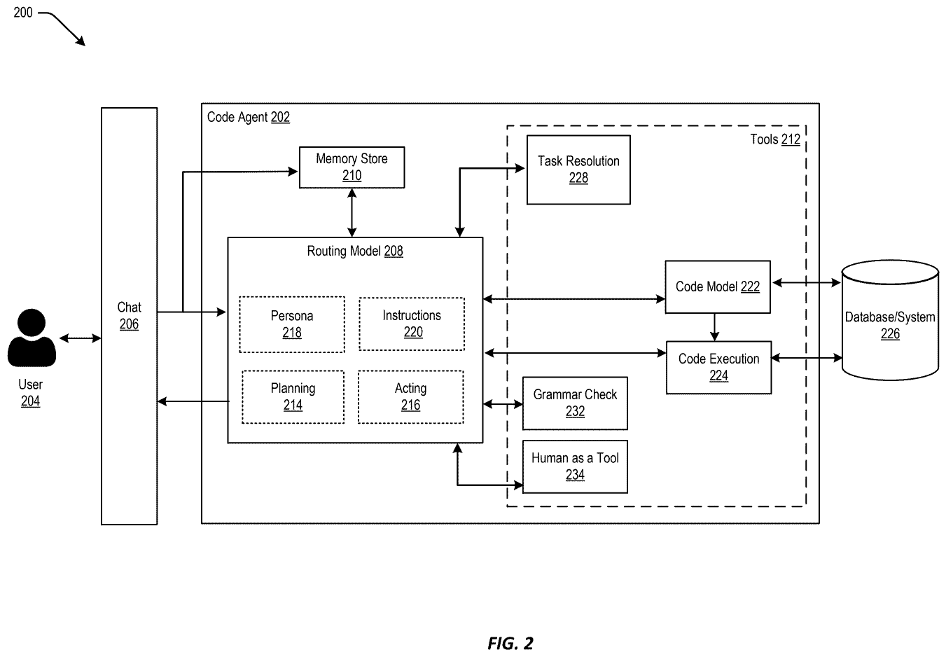

FIG. 2 is a simplified block diagram of a code agent system 200 according to certain embodiments, code agent system 200 is a computing system that can be implemented in software only, hardware only, firmware only, or any combination of hardware, software, and/or firmware. The code agent system 200 can execute various code tasks in response to natural language questions to help users complete their code tasks by leveraging the power of generative artificial intelligence such as LLMs. In addition to their code task capabilities (e.g., code generation, completion, explanation, documentation or unit test generation), generative artificial intelligence can generate natural language responses as part of a conversation with the user. The purpose of the code agent system 200 is to enable users to complete their code tasks with the least amount of effort. This may include the code agent system 200 interpreting user requests in natural language, reviewing code, determining the code task to be performed, performing the code task, and generating a response and even causing the execution of the code. In certain embodiments, the code agent system 200 can be used to implement one or more tools related to code tasks (e.g., code tool 104 as described with respect to FIG. 1). The code agent system 200 can include a code agent 202 capable of performing one or more code tasks.

A user 204 can participate in a chat 206 (also described herein as a conversation or an interaction) with the code agent 202. The user 204 may interact with the chat 206 via a user interface such as a graphical user interface or conversational user interface. As an example, the user 204 may provide a user input to the code agent 202 via a user interface element such as a chat window. The chat 206 can include one or more inputs from the user 204 and one or more responses from the code agent 202. The chat 206 may correspond to one or more chat sessions between the user 204 and the code agent 202. During the chat 206, the user 204 provides a natural language utterance that can be processed by the code agent 202. The natural language utterance can include a question related to a code task.

One or more user inputs provided by the user 204 via the chat 206 are provided to the code agent 202. Included in the code agent 202 are a routing model 208, a memory store 210 and tools 212. The routing model 208 and memory store 210 receive user inputs such as natural language utterances from the chat 206. The memory store 210 can store a chat history for the user 204 and contextual information related to the user 204, the chat 206, and/or other pieces of information relevant to the code task operations such as in-context examples, APIs (e.g., API to a code repository), external knowledge, and the like. The tools 212 can include functions, APIs, and trained machine learning models that can be used by the code agent 202 to interact with external systems (e.g., database or system 226, external knowledge bases) and/or generate responses.

The routing model 208 may be or may make use of one or more generative artificial intelligence models such as LLMs. The routing model 208 can include a planning 214 component and an acting 216 component (e.g., trained task). Planning 214 includes generating a plan that is comprised of a sequence of steps for execution (acting 216), which includes executing the steps in a generated plan using one or more tools 212. In some examples, the routing model 208 may retrieve contextual information related to the user 204 and/or chat 206 from the memory store 210 during planning 214 to improve plan generation. Planning 214 may further include determining a new plan based on a result produced by acting 216 and the execution of a previous plan.

One or more tools 212 supported by the code agent 202 may be LLM-based tools configured to receive a prompt and generate a response and/or result based at least in part on the prompt. As an example, the tools 212 can include an LLM-based code model 222 that generates response based on a prompt including a natural language utterance provided by the user 204 (e.g., as described in FIG. 1). In some instances, the routing model 208 can generate a prompt based on a natural language utterance received from the user 204. In some examples, steps for generating a prompt can be included in a plan generated by planning 214 and the prompt may be generated by acting 216. A prompt can include a persona 218 and instructions 220. The persona 218 can be selected from a set of available personas (see Table 1 for a non-limiting list of exemplary personas). Including the persona 218 in a prompt for an LLM may improve accuracy of generated responses and customize responses generated by an LLM to the needs of the user 204. In some examples, planning 214 may select a tool from the tools 212 based on the persona 218.

TABLE 1

| Example | |
|---|---|
| Persona | Example Description |
| Junior | A user having limited to no experience in writing code that |
| Developer | requires assistance in writing and optimizing code. |
| Expert | A user with several years of experience writing code. |
| Developer | |
| Business | A user with strong context about the needs of a company |
| Analyst | and wants quick data insights without deep programming or |
| | coding knowledge. |
| Data | A user focused on extracting and analyzing data efficiently. |
| Scientist | |

Instructions 220 describe the knowledge bases and tools available to the code agent 202. Instructions 220 can be included in a prompt for LLM-based tools and may guide a tool to generate a response relevant to preferences of user 204. Additionally, or alternatively, the prompt can include context, in-context examples, instructions, a user question, snippets of code, or any combination thereof. In some examples, context may include contextual information related to the user 204 and/or chat 206 history and may be retrieved from the memory store 210 by the routing model 208. The prompt may further include code snippets corresponding to a codebase.

The routing model 208 may provide the generated prompt to a tool from the tools 212 selected by planning 214. As an example, the code model 222 receives a prompt provided by the routing model 208 and generates response based on the prompt. The code model 222 can be trained to execute code tasks and generate responses to help the user 204 complete code tasks. In some examples, the responses generated by the code model 222 are returned to the user 204 via the chat 206. Additionally, or alternatively, the generated responses are provided to a code execution 224 tool that is configured to execute code on the database or system 226. Code execution 224 may receive a result from the database or system 226 and provide the result to the routing model 208. The routing model 208 may provide the result to the user 204 via the chat 206. In some implementations, the routing model 208 may identify an error in the result or determine the response and/or result does not correspond to user 204 needs and generate new plan using planning 214 to correct the error or generate a new response and/or result.

Additional examples of tools include, but are not limited to, task resolution 228, grammar check 232, and human as a tool 234. Task resolution 228 may be configured to check for and/or fix any errors with execution of code task and/or within a response. The code agent 202 may use task resolution 228 before or after a response is generated by the code model 222. Schema linking 230 may be configured to identify proper references to schema values (e.g., tables, columns, condition values) based on schema information and query patterns. Also included in the tools 212 is a grammar check 232 that can review grammar of generated responses. Tools 212 can also include human as a tool 234. The code agent 202 may seek human input for clarification and disambiguation. Human as a tool 234 may be used to supplement one or more additional tools of the set of tools 212 with human input or intervention. Human as a tool 234 can include asking the user 204 or another user such as a developer for information for correcting previous generations.

The code agent 202 may use a singular tool or a combination of tools 212 to generate a response to the user 204. The routing model 208 can select a tool and/or generate a prompt for the selected tool based on a natural language utterance received via the chat 206. The routing model 208 receives an output from the selected tool based on the prompt and/or context provided to the selected tool. In some implementations, the output generated by the selected tool is provided to the user 201 via the chat 202 as received by the routing model 208 (e.g., without additional modifications to the output).

In some implementations, the routing model 208 responds to the user 204 which provided the original query as part of a two-way conversation (e.g., via chat 206). The natural language response may include a natural language component (e.g., answers to questions, information, etc.) and/or a code component (e.g., a snippet of generated code). In some embodiments, the routing model 208 may generate a natural language response containing the output generated by the selected tool. The routing model 208 may be configured to generate the natural language response and/or may use a response generation tool to generate the natural language response. The natural language response can be provided to the user 201 via the chat 206. In some implementations, the code agent 202 may provide a visualization of the generated result through a plot, table, graph, and the like, via the chat 206. As a particular example, the code agent 202 can use the task resolution 228 tool to determine code task in a natural language utterance (which is an example of NL utterance 102 with respect to FIG. 1) provided by the user 204 and then generate response using the code model 222 based on the code task. The response may be provided to the user 201 via the chat 202 as generated by the code model 222. In some implementations, the routing model 208 may generate a natural language response containing the code task execution and/or results and provide the natural language response to the user 201 via the chat 202.

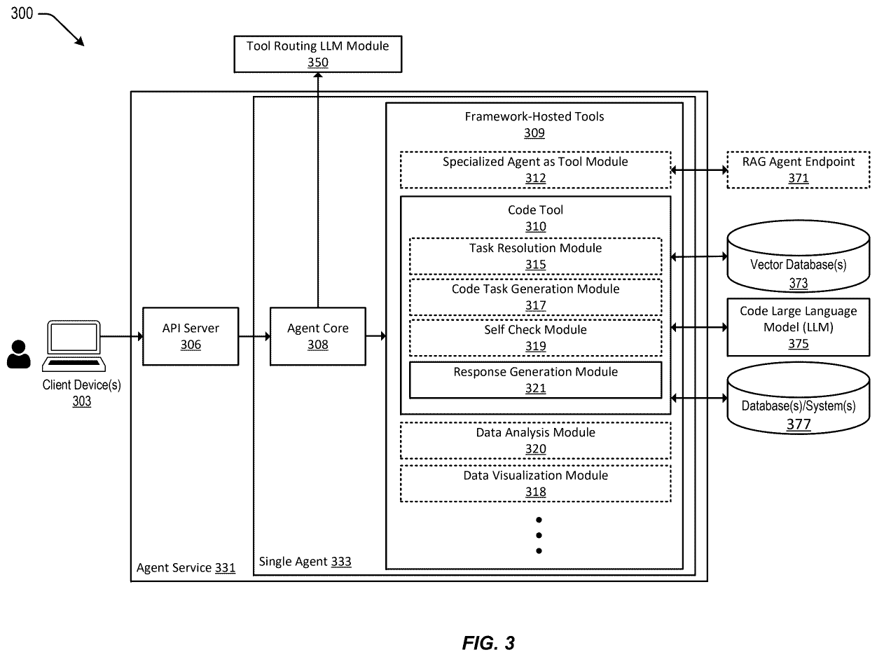

FIG. 3 depicts a simplified diagram 300 for an example generative AI code agent, according to various embodiments. As discussed in regard to FIGS. 1 and 2, user(s) (e.g., users 101 or 204) may use client device(s) 303 to submit a NL utterance and/or question to an agent service 331 by way of an API server 306. The API server 306 may be a software, hardware, and/or firmware component that enables one or more applications (e.g., cloud applications) to enable communication as an intermediary between the client device(s) 303 and the agents. The API server 306 may identify a specific agent (e.g., single agent 333), or multiple agents, to handle the instance (e.g., by agent specialty or user preference) and select an agent core 308. The agent core 308 may be configured with pass-through routing or, if additional tools are included in the agent, a specific routing (e.g., ReAct routing) may be implemented. The agent core 308 may handle multi-step (or iterated) code task resolution, task execution such as code generation, and/or execution. By way of a non-limiting example, in various code task use cases using unique software packages (e.g., IDE plugins for IntelliJ, VSCode, OCI Code Editor and other IDEs, etc.), a single or multiple interfaces may generate code task response using input from one or more users. The agent core 308 may access a tool routing LLM module 350 in order to identify, select, utilize, and/or train one or more LLM(s) that may suitably execute a code task described in an utterance received from the client device(s) 303.

The agent core 308 may include one or more framework-hosted tools 309 for addressing various functions. For example, the framework-hosted tools 309 may include a specialized agent as tool module 312 which may be in communication with a retrieval augmented generation (RAG) endpoint 371. The RAG endpoint 371 may improve an efficacy of one or more LLMs by suitably leveraging various sources of data. For example, retrieving data/documents relevant to the utterance (e.g., question, code, task, etc.) and providing them as context for the LLM as either labeled or unlabeled data. The RAG endpoint 371 may provide support to the agent core and maintain up-to-date information based at least in part on other trained LLMs and/or agent cores (not depicted), and/or access domain-specific knowledge.

Included in the framework hosted tools 309 is a code tool 310, which is an example of the code model 218 with respect to FIG. 2. The code tool 310 includes, without limitation, modules 315, 317, 319, and 321. Task resolution module 315 may function to receive input from the client device(s) 303 requesting the code tool 310 check the task request or code for any errors (e.g., syntax errors, sematic errors, etc.) and fix the errors (or recommend a fix). The agent core 308 may provide explanations to the client device(s) 303 about each fix performed. The explanations may be provided in natural language. In some examples, the code tool 310 may attempt to automatically resolve the errors if possible and ask clarification questions (e.g., as output to the client device(s) 303) where suitably needed. If the error cannot be resolved, the error may be displayed to the user(s). As an example, the different types of errors that an agent core 308 (which is an example component of code agent 202 with respect to FIG. 2) may return can include syntax errors and semantic errors. The task resolution module 315 may reference one or more vector database(s) 373 to obtain and/or store various code tasks and descriptions thereof.

Also included in the code tool 310 is a code task generation module 317. The code task generation module 317 may take the utterance received from the client device(s) 303 and perform one or more code tasks such as generate code. To do this, the code tool 310 may access one or more generative artificial intelligence models such as LLMs (e.g., SQL LLM 375) that may have been trained on performing the one or more code tasks. An LLM may receive the utterance from the code tool 310 and may perform the one or more code tasks. The code task generation module 317 may then pass the task output from the LLM to one or more additional modules. For example, the task code generation module 317 may pass the generated code returned from the LLM to a response generation module 321. The response generation module 321 may append the generated code (optionally along with information related to the utterance) and return the response to the client device(s) 303. In addition, or alternatively, the response generation module 321 may pass the task output and/or the response to one or more database(s) or system(s) 377 to execute the code related to the utterance. The code tool 310 may utilize a self-check module 319, which may function with any one or more of the other modules. The self-check module 319 may automatically try to resolve errors associated with the task output and/or LLM prompt containing the utterance. The self-check module 319 may ask clarifying questions to the client device(s) 303 and/or the LLM to resolve the errors.

The framework-hosted tools 309 includes data analysis module 320 and a data visualization module 318. Each of 320 and 318 may function with any of the modules of the framework-hosted tools 309 in order to analyze various analytics and display the various analytics. The analytics may include analysis of code, code tasks, LLM accuracy, recommendations, or suitable equivalents.

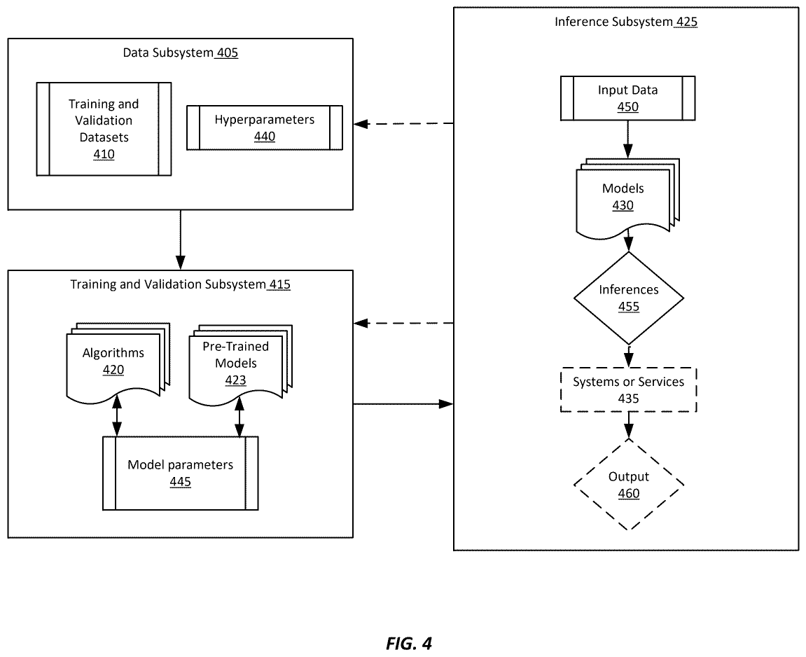

FIG. 4 shows a block diagram of an AI Platform 400 comprising several subsystems that work together to train, validate, and implement one or more machine learning models in accordance with various embodiments. The AI Platform 400 may be executed as part of the code tool, code agent system, and/or AI code agent described in FIGS. 1, 2, and 3 to train or fine-tune one or more machine learning models (e.g., one or more generative models) with training data—and deploy and use said one or more machine learning models as described herein.

The AI Platform 400 comprises a data subsystem 405 for collecting, generating, preprocessing, and labeling of training and validation datasets 410, training and validation subsystem 415 that facilitates the training and validation of one or more machine learning algorithms 420 or one or more pre-trained machine learning models 423, and inference subsystem 425 for deploying and implementing one or more trained machine learning models 430 independently or in combination with one or more other systems or services 435 for downstream processes.

As used herein, machine learning algorithms (also described herein as simply algorithm or algorithms) are procedures that are run on datasets (e.g., training and validation datasets) and perform pattern recognition on datasets, learn from the datasets, and/or are fit on the datasets. Examples of machine learning algorithms include linear and logistic regression, decision trees, artificial neural networks, k-means, transformer architectures with attention mechanisms, and k-nearest neighbor. In contrast, machine learning models (also described herein as simply model or models) are the output of the machine learning algorithms and are comprised of model data and a prediction algorithm. In other words, the machine learning model is the program that is saved after running a machine learning algorithm on training data and represents the rules, numbers, and any other algorithm-specific data structures required to make inferences. For example, a linear regression algorithm may result in a model comprised of a vector of coefficients with specific values, and a transformer architecture with attention mechanisms may result in a LLM that utilizes self-attention mechanisms, allowing the model to weigh the importance of different words in a sentence when making predictions.

In the specific context of this disclosure, the machine learning model(s) may be one or more generative models. A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text or code synthesis, and more sophisticated tasks like unsupervised learning, semi-supervised learning, and domain adaptation.

One type of generative model is a large language model (LLM). Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times and inference latency times.

A mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

Transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a softmax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

Following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

Integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

Another type of generative model is a large multimodal model (LMM). A large multimodal model is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of large multimodal models. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

### Data Subsystem

Data subsystem 405 is used to collect, generate, preprocess, and label data to be used to train and validate one or more machine learning algorithms 420 or one or more pre-trained machine learning models 423. The data collection can include exploring various data sources such as public datasets, private data collections, or real-time data streams, depending on a project's needs. In some instances, a data source is a public or online repository of information or examples pertinent to a general or target domain space (e.g., Java codebase or code repository). Many domains have publicly available datasets provided by governments, universities, or organizations. For example, many government and private entities offer datasets on healthcare, environmental data, and more through various portals. For proprietary needs, data might be available through partnerships or purchases from private companies that specialize in data aggregation. In other instances, a data source is a private repository of information or examples pertinent to a general or target domain space (e.g., Java codebase or code repository). For example, a data source can be the storage device that stores code accessed by the code tool, code agent system, and/or AI code agent described in FIGS. 1, 2, and 3. Once a data source is identified, data subsystem 405 can be used to collect data through appropriate methods such as downloading from online repositories, web scraping, using APIs for real-time data, creating datasets through surveys and requests for access, or by running programs or scripts. The acquired raw data may be further preprocessed to generate the training and validation datasets 410.

In some instances, raw data (e.g., text scripts and associated audio) may be generated as opposed to being collected or acquired. Data generating may comprise data synthesis and/or data augmentation. Different data synthesis and/or data augmentation techniques may be implemented by data subsystem 405 to generate data to be used for the training and validation subsystem 415. Data synthesizing involves creating entirely new data points from scratch. Data synthesis may be used when real data is insufficient, too sensitive to use, or when the cost and logistical barriers to obtaining more real data are too high. The synthesized data should be realistic enough to effectively train a machine learning model, but distinct enough to comply with regulations (e.g., copyright and data privacy), if necessary. Data augmentation, on the other hand, refers to techniques used to artificially expand the size of a dataset by creating modified versions of existing data examples. The primary goal of data augmentation is to increase variation in the data in order to make the model more robust to variations it might encounter in the real world, thereby improving its ability to generalize from the training data to unseen data. This is especially common in image and speech recognition tasks but is applicable to other data types as well. For images, data augmentation may include rotations, flipping, scaling, or altering the lighting conditions. For text, data augmentation may include synonyms replacement, back translation, or sentence shuffling. For audio, data augmentation may include changes made to pitch, speed, or background noise.

Preprocessing may be implemented by data subsystem 405, serving as a bridge between raw data acquisition and effective model training. The primary objective of preprocessing is to transform the raw data into a format that is more suitable and efficient for analysis, ensuring that the data fed into machine learning algorithms or pretrained models is clean, consistent, and relevant. This step can be useful because raw data often comes with a variety of issues such as missing values, noise, irrelevant information, and inconsistencies that can significantly hinder the performance of a model. By standardizing and cleaning the data beforehand, preprocessing helps in enhancing the accuracy and efficiency of the subsequent analysis, making the data more representative of the underlying problem the model aims to solve.

Other raw data preprocessing techniques that may be utilized include data cleaning, normalization, feature extraction, dimensionality reduction, and the like. Data cleaning may involve removing duplicates, filling in missing values, or filtering out outliers to improve data quality. Normalization involves scaling numeric values to a common scale without distorting differences in the ranges of values, which helps prevent biases in the model due to the inherent scale of features. Feature extraction involves transforming the input data into a set of usable features, possibly reducing the dimensionality of the data in the process. For instance, in audio analysis, feature reduction techniques such as Principal Component Analysis (PCA), Linear Discriminant Analysis (LDA), t-Distributed Stochastic Neighbor Embedding (t-SNE), Non-Negative Matrix Factorization (NMF), and feature selection can be used for simplifying the representation of audio signals while retaining the most relevant information for tasks like classification, recognition, or synthesis. These techniques not only help in reducing the computational load on the model but also in mitigating issues like overfitting by simplifying the data without losing critical information.

In the instance that AI Platform 400 is used for supervised or semi-supervised learning of machine learning models, labeling techniques can be implemented as part of the data collection. The quality and accuracy of data labeling directly influence the model's performance, as labels serve as the definitive guide that the model uses to learn the relationships between the input features and the desired output. Particularly in complex domains such as image analysis, natural language processing, or medical diagnosis, precise and consistent labeling is important because it provides the ground truth or target outcomes against which the model's predictions are compared and adjusted during training. Effective labeling ensures that the model is trained on correct and clear examples, thus enhancing its ability to generalize from the training data to real-world scenarios. In some instances, the annotation labels and ground truth values (labels) are appended or annotated within the raw data. For example, when the raw data includes text scripts, the labels may include one or more spans and corresponding named entities.

Labeling techniques can vary significantly depending on the type of data and the specific requirements of the project. Manual labeling, where human annotators label the data, is one method that can be used. This approach may be useful when a detailed understanding and judgment are required, such as in labeling medical text or categorizing text data where context and subtlety are important. However, manual labeling can be time-consuming and prone to inconsistency, especially with a large number of annotators. To mitigate this, semi-automated labeling tools may be used as part of data subsystem 405 to pre-label data using algorithms, which human annotators may then review and correct as needed. Another approach is active learning, a technique where the model being developed is used to label new data iteratively. The model suggests labels for new data points, and human annotators may review and adjust certain predictions such as the most uncertain predictions. This technique optimizes the labeling effort by focusing human resources on a subset of the data, e.g., the most ambiguous cases, improving efficiency and label quality through continuous refinement.

Once collected, generated, preprocessed, and/or labeled, the data may then be split into the training and validation datasets 410. The training and validation datasets 410 may comprise the raw data and/or the preprocessed data. The training and validation datasets 410 are typically split into at least three subsets of data: training, validation, and testing. The training set is used to fit the model, where the machine learning model learns to make inferences based on the training data. The validation set, on the other hand, is utilized to tune hyperparameters and prevent overfitting by providing a sandbox for model selection. Finally, the test set serves as a new and unseen dataset for the model, used to simulate real-world application and evaluate the final model's performance. The process of splitting ensures that the model can perform well not just on the data it was trained on, but also on new, unseen data, thereby validating and testing its ability to generalize.

Various techniques can be employed to split the data effectively, with each method aiming to maintain a good representation of the overall dataset in each subset. A simple random split (e.g., a 70/20/10%, 80/10/10%, or 60/25/15%) is the most straightforward approach, where examples from the data are randomly assigned to each of the three sets. In some instances, the splitting is performed such that 70% of the training and validation datasets 410 are for training, 10% are for validation, and 20% are for testing. However, more sophisticated methods may be necessary to preserve the underlying distribution of data. For instance, stratified sampling may be used to ensure that each split reflects the overall distribution of a specific variable, particularly useful in cases where certain categories or outcomes are underrepresented. Another technique, k-fold cross-validation, involves rotating the validation set across different subsets of the data, maximizing the use of available data for training while still holding out portions for validation. These methods help in achieving more robust and reliable model evaluation and are useful in the development of predictive models that perform consistently across varied datasets.

Data subsystem 405 is also used for collecting, generating, setting, or implementing model hyperparameters 440 for the training and validation subsystem 415. The hyperparameters control the overall behavior of the models. Unlike model parameters 445 that are learned automatically during training, hyperparameters 440 are set before training begins and have a significant impact on the performance of the model. For example, in a neural network such as that of an LLM, hyperparameters include the learning rate, number of layers, number of neurons/nodes per layer, activation functions, convolution kernel width, the number of kernels for a model, among others. These settings can determine how quickly a model learns, its capacity to generalize from training data to unseen data, and its overall complexity. Correctly setting hyperparameters is important because inappropriate values can lead to models that underfit or overfit the data. Underfitting occurs when a model is too simple to learn the underlying pattern of the data, and overfitting happens when a model is too complex, learning the noise in the training data as if it were signal.

### Training, Validation, and Testing

The training and validation subsystem 415 is comprised of a combination of specialized hardware and software to efficiently handle the computational demands required for training, validating, and testing a machine learning model. On the hardware side, high-performance GPUs (Graphics Processing Units) may be used for their ability to perform parallel processing, drastically speeding up the training of complex models, especially deep learning networks. CPUs (Central Processing Units), while generally slower for this task, may also be used for less complex model training or when parallel processing is less critical. TPUs (Tensor Processing Units), designed specifically for tensor calculations, provide another level of optimization for machine learning tasks. On the software side, a variety of frameworks and libraries are utilized, including TensorFlow, PyTorch, Keras, and scikit-learn. These tools offer comprehensive libraries and functions that facilitate the design, training, validation, and testing of a wide range of machine learning models across different computing platforms, whether local machines, cloud-based systems, or hybrid setups, enabling developers to focus more on model architecture and less on underlying computational details.

Training is the initial phase of developing machine learning models 430 or fine-tuning is subsequent training phases for fine-tuning machine learning models 430 where the model learns to make predictions or decisions based on data training data provided from the training and validation datasets 410. During this phase, the model iteratively adjusts its internal model parameters 445 to achieve a preset optimization condition. In a supervised machine learning training process, the preset optimization condition can be achieved by minimizing the difference between the model output (e.g., predictions, classifications, or decisions) and the ground truth labels in the training data. In some instances, the preset optimization condition can be achieved when the preset fixed number of iterations or epochs (full passes through the training dataset) is reached. In some instances, the preset optimization condition is achieved when the performance on the validation dataset stops improving or starts to degrade. In some instances, the preset optimization condition is achieved when a convergence criterion is met, such as when the change in the model parameters falls below a certain threshold between iterations. This process, known as fitting, is fundamental because it directly influences the accuracy and effectiveness of the model.

In an exemplary training phase performed by the training and validation subsystem 415, the training subset of data is input into the machine learning algorithms 420 or pre-trained models 423 to find a set of model parameters 445 (e.g., weights, coefficients, trees, feature importance, and/or biases) that minimizes or maximizes an objective function (e.g., a loss function, a cost function, a contrastive loss function, a cross-entropy loss function, an Out-of-Bag (OOB) score, etc.). To train the machine learning algorithms 420 or pre-trained models 423 to achieve accurate predictions, “errors” (e.g., a difference between a predicted label and the ground truth label) need to be minimized. In order to minimize the errors, the model parameters can be configured to be incrementally updated by minimizing the objective function over the training phase (“optimization”). Various different techniques may be used to perform the optimization. For example, to train machine learning algorithms or pre-trained models such as a neural network, optimization can be done using back propagation. The current error is typically propagated backwards to a previous layer, where it is used to modify the weights and bias in such a way that the error is minimized. The weights are modified using the optimization function. Other techniques such as random feedback, Direct Feedback Alignment (DFA), Indirect Feedback Alignment (IFA), Hebbian learning, and the like can also be used to update the model parameters 445 in a manner as to minimize or maximize an objective function. This cycle is repeated until a desired state (e.g., a predetermined minimum value of the objective function) is reached.

The training phase is driven by three primary components: the model architecture (which defines the structure of the algorithm(s) 420 or pretrained model(s) 423), the training data (which provides the examples from which to learn), and the learning algorithm (which dictates how the model adjusts its model parameters). The goal is for the model to capture the underlying patterns of the data without memorizing specific examples, thus enabling it to perform well on new, unseen data.

The model architecture is the specific arrangement and structure of the various components and/or layers that make up a model. In the context of a neural network, the model architecture may include the configuration of layers in the neural network, such as the number of layers, the type of layers (e.g., convolutional, recurrent, fully connected), the number of neurons in each layer, and the connections between these layers. In the context of a LLM comprised of a transformer architecture, which utilizes self-attention mechanisms to process and generate human-like text. The transformer model comprises an encoder-decoder structure, where the encoder processes the input text, and the decoder generates the output. The self-attention mechanism allows the model to weigh the importance of different words in a sentence, capturing long-range dependencies and contextual relationships. This architecture enables the model to handle large-scale data and understand complex language patterns. During training, optimization algorithms such as Adam are used to minimize the loss function through backpropagation, and regularization techniques like dropout are employed to prevent overfitting, resulting in a robust and efficient language model capable of performing various natural language processing tasks such as predicting the ADR relations.

The model architecture also encompasses the choice and arrangement of features and algorithms used in various models, such as neural networks and transformers. The architecture determines how input data is processed and transformed through various computational steps to produce the output. The model architecture directly influences the model's ability to learn from the data effectively and efficiently, and it impacts how well the model performs tasks such as classification, regression, or prediction, adapting to the specific complexities and nuances of the data it is designed to handle.

The learning algorithm is the overall method or procedure used to adjust the model parameters 445 to fit the data. It dictates how the model learns from the data provided during training. This includes the steps or rules that the algorithm follows to process input data and make adjustments to the model's internal parameters (e.g., weights in neural networks) based on the output of the objective function. Examples of learning algorithms include gradient descent, backpropagation for neural networks, and splitting criteria in decision trees.

Various techniques may be employed by training and validation subsystem 415 to train machine learning models 430 using the learning algorithm, depending on the type of model and the specific task. For supervised learning models, where the training data includes both inputs and expected outputs (e.g., ground truth labels), gradient descent is a possible method. This technique iteratively adjusts the model parameters 445 to minimize or maximize an objective function (e.g., a loss function, a cost function, a contrastive loss function, etc.). The objective function is a method to measure how well the model's predictions match the actual labels or outcomes in the training data. It quantifies the error between predicted values and true values and presents this error as a single real number. The goal of training is to minimize this error, indicating that the model's predictions are, on average, close to the true data. Common examples of loss functions include mean squared error for regression tasks and cross-entropy loss for classification tasks.

The adjustment of the model parameters 445 is performed by the optimization function or algorithm, which refers to the specific method used to minimize (or maximize) the objective function. The optimization function is the engine behind the learning algorithm, guiding how the model parameters 445 are adjusted during training. It determines the strategy to use when searching for the best weights that minimize (or maximize) the objective function. Gradient descent is a primary example of an optimization algorithm, including its variants like stochastic gradient descent (SGD), mini-batch gradient descent, and advanced versions like Adam or RMSprop, which provide different ways to adjust learning rates or take advantage of the momentum of changes. For example, in training a neural network, backpropagation may be used with gradient descent to update the weights of the network based on the error rate obtained in the previous epoch (cycle through the full training dataset). Another technique in supervised learning is the use of decision trees, where a tree-like model of decisions is built by splitting the training dataset into subsets based on an attribute value test. This process is repeated on each derived subset in a recursive manner called recursive partitioning.

In unsupervised learning, where training data does not include labels, different techniques are used. Clustering is one method where data is grouped into clusters that maximize the similarities of data within the same cluster and maximize the differences with data in other clusters. The K-Means algorithm, for example, assigns each data point to the nearest cluster by minimizing the sum of distances between data points and their respective cluster centroids. Another technique, Principal Component Analysis (PCA), involves reducing the dimensionality of data by transforming it into a new set of variables, the principal components, which are uncorrelated and ordered so that the first few retain most of the variation present in all of the original variables. These techniques help uncover hidden structures or patterns in the data, which can be essential for feature reduction, anomaly detection, or preparing data for further supervised learning tasks.

Validating is another phase of developing machine learning models 430 where the model is checked for deficiencies in performance and the hyperparameters 440 are optimized based on validation data provided from the training and validation datasets 410. The validation data helps to evaluate the model's performance, such as accuracy, precision, recall, or F1-score, to gauge how well the model is likely to perform in real-world scenarios. Hyperparameter optimization, on the other hand, involves adjusting the settings that govern the model's learning process (e.g., learning rate, number of layers, size of the layers in neural networks) to find the combination that yields the best performance on the validation data. One optimization technique is grid search, where a set of predefined hyperparameter values are systematically evaluated. The model is trained with each combination of these values, and the combination that produces the best performance on the validation set is chosen. Although thorough, grid search can be computationally expensive and impractical when the hyperparameter space is large. A more efficient alternative optimization technique is random search, which samples hyperparameter combinations from a defined distribution randomly. This approach can in some instances find a good combination of hyperparameter values faster than grid search. Advanced methods like Bayesian optimization, genetic algorithms, and gradient-based optimization may also be used to find optimal hyperparameters more effectively. These techniques model the hyperparameter space and use statistical methods to intelligently explore the space, seeking hyperparameters that yield improvements in model performance.

An exemplary validation process includes iterative operations of inputting the validation subset of data into the trained algorithm(s) using a validation technique such as K-Fold Cross-Validation, Leave-one-out Cross-Validation, Leave-one-group-out Cross-Validation, Nested Cross-Validation, or the like, to fine-tune the hyperparameters and ultimately find the optimal set of hyperparameters. In some instances, a 5-fold cross-validation technique may be used to avoid overfitting the trained algorithm and/or to limit the number of selected features per split to the square-root of the total number of input features. In some instances, training dataset is split into 5 equal-size cohorts (or about equal-size), and every four of the cohorts are used to train an algorithm to generate five models (e.g, cohorts #1, 2, 3, and 4 are used to train and generate model 1, cohorts #1, 2, 3, and 5 are used to train and generate model 2, cohorts #1, 2, 4, and 5 are used to train and generate model 3, cohorts #1, 3, 4, and 5 are used to train and generate model 4, and cohorts #2, 3, 4 and 5 are used to train and generate model 5). Each model is evaluated (or validated) using the unused cohort in the training (e.g., for model 5, cohort #1 is used for validation). The overall performance of the training can be evaluated by an average performance of the five models. K-fold cross-validation provides a more robust estimate of a model's performance compared to a single training/validation split because it utilizes the entire dataset for both training and evaluation and reduces the variance in the performance estimate.

Once a machine learning model has been trained and validated, it undergoes a final evaluation using test data provided from the training and validation datasets 410, which is a separate subset of the data that has not been used during the training or validation phases. This step is crucial as it provides an unbiased assessment of the model's performance in simulating real-world operation. The test dataset serves as new, unseen data for the model, mimicking how the model would perform when deployed in actual use. During testing, the model's predictions are compared against the true values in the test dataset using various performance metrics such as accuracy, precision, recall, and mean squared error, depending on the nature of the problem (classification or regression). This process helps to verify the generalizability of the model-its ability to perform well across different data samples and environments-highlighting potential issues like overfitting or underfitting and ensuring that the model is robust and reliable for practical applications. The machine learning models 430 are fully validated and tested once the output predictions have been deemed acceptable by user defined acceptance parameters. Acceptance parameters may be determined using correlation techniques such as Bland-Altman method and the Spearman's rank correlation coefficients and calculating performance metrics such as the error, accuracy, precision, recall, receiver operating characteristic curve (ROC), etc.

### Inference Phase for Machine Learning Models

The inference subsystem 425 is comprised of various components for deploying the machine learning models 430 in a production environment (e.g., use as cloud service as described with respect to FIGS. 9-13). Deploying the machine learning models 430 includes moving the models from a development environment (e.g., the training and validation subsystem 415, where it has been trained, validated, and tested), into a production environment where it can make inferences on real-world data (e.g., input data 450). This step typically starts with the model being saved after training, including its parameters and configuration such as final architecture and hyperparameters. It is then converted, if necessary, into a format that is suitable for deployment, depending on the deployment environment. For instance, a model trained in a scientific computing environment such as Python might be converted into a Java-friendly format for integration into a larger enterprise application.

Deployment can be conducted on various platforms, including on-premises servers or cloud environments like Oracle's Cloud Infrastructure (OCI), as described in greater detail with respect to FIGS. 9-13. In some instances, a portion of or the code tool, code agent system, and/or AI code agent described in FIGS. 1, 2, and 3 can be bundled into an application using a software framework such as Gradio or LangChain, which is executable on one or more of the various platforms. A Gradio application is an open-source Python package that allows a user to quickly build a demo or web application for their machine learning model, API, or any arbitrary Python function (e.g., a could service application). LangChain provides utilities for integrating generative models into applications. The application can be built to enable users to play around with the training data generator in a playground mode, as well as generate training dataset in bulk, train models using the training dataset, and use the models in a production environment.

Once deployed, the model is ready to receive input data 450 and return outputs (e.g., inferences 455). In some instances, the model resides as a component of a larger system or service (e.g., including additional downstream applications 435). In some instances, the models 430 and/or the inferences 455 can be used by the downstream applications 435 to provide further information. For example, the inferences 455 can be used for converting text to audio, detecting audio, converting audio to text, executing code, and the like. The downstream applications can be configured to generate an output 460. In some instances, the output 460 comprises a report including inferences 455 and information generated by the downstream applications 435.

To manage and maintain its performance, a deployed model may be continuously monitored to ensure it performs as expected over time. This involves tracking the model's prediction accuracy, response times, and other operational metrics. Additionally, the model may require retraining or updates based on new data or changing conditions in the environment it is applied in. This can be useful because machine learning models can drift over time due to changes in the underlying data, they are making predictions on-a phenomenon known as model drift. Therefore, maintaining a machine learning model in a production environment often involves setting up mechanisms for performance monitoring, regular evaluations against new test data, and potentially periodic updates and retraining of the model to ensure it remains effective and accurate in making predictions.

### Preference Alignment Training

As discussed herein, foundational generative models are rapidly improving. However, enhancing these models, especially strong code models, is a highly challenging task. Even with advanced code models, as demonstrated in the Alpha Program (using Phind-CodeLlama-34B-V2), many issues arise in real-world scenarios when developers rely on responses from code models. More specifically, conventional code models have been trained on vast amounts of web-scale data, giving them a solid foundation in general coding knowledge. However, they still face challenges when it comes to specific coding tasks or skills such as unit test generation. Studies conducted with internal Java developers, revealed that even a powerful code model like Phind-CodeLlama-34B-V2 (one of the strongest code LLMs at the time) struggled with certain Java-specific coding skills or tasks such as code generation, completion, explanation, documentation or unit test generation.

To address these challenges and others, an effective data collection and training strategy tailored to a user's specific context is needed, which includes limited access to public data due to various restrictions including legal restrictions and targeted use cases for code developers (e.g., Java developers) that differ significantly from public benchmarks like HumanEval or DS-1000. The preference alignment training framework and techniques described herein implement an effective data collection and training strategy for fine-tuning code models to be used in an AI-based coding assistant addressing these challenges and others.

An AI-based coding assistant is powered by a deep learning model (e.g., a code model such as an LLM) configured to execute one or more code tasks and generate a response based on a natural language (NL) utterance (e.g., a query posed by a user using a digital assistant or chatbot). Users of a code development service may want the AI-based coding assistant to perform various coding tasks such as code documentation, code explanation, unit test generation, code completion, or code review that comply with the rules and constraints of a particular programming language and/or user. To provide various code tasks with proper programming language handling, a code model can be fine-tuned with synthesized fine-tuning data. The synthesized fine-tuning data is generated using a verticalization system and process that has been customized to target specific coding skills, including code documentation, code explanation, unit test generation, code completion, and code review. The verticalization system and process focuses on fine-tuning existing LLMs by leveraging internal user code data to enhance their performance in code-specific tasks. In some instances, a preference alignment training framework can be implemented with a data synthesis approach aimed at generating PAT examples for enhancing code skills such as unit test generation capabilities of the existing LLMs. A fine-tuned code model may be deployed within the code agent system and can generate responses that comply with the rules and constraints of a particular programming language with improved and optimized accuracy.

In the data curation pipeline of the framework, it is ensured that the chosen (selected) unit tests follow a more thorough testing path, including edge and corner cases, and achieve high coverage. The rejected unit tests are typically human-written unit tests that tend to follow happy path testing (e.g., lacking or having fewer edge and corner cases) and/or have lower coverage. To synthesize the PAT examples (e.g., the chosen (selected) unit tests), techniques disclosed herein utilize a base generative model (e.g., Qwen2-72B-Instruct or Meta-Llama-3-70B-Instruct) to synthesize example data by leveraging in-context learning with examples from a small set of high-quality data, e.g., human-generated data. Thereafter, PAT example pairs comprising “chosen” and “rejected” examples are created. The chosen example is the synthesized data from the based generative model, while the rejected example is the original example data (e.g., human-written unit tests). Preference optimization algorithms (e.g., DPO) are then applied to enhance the base model's performance using the “chosen” and “rejected” examples. For example, a generative model (e.g., the smaller or base LLM) can be trained or fine-tuned with the “chosen” and “rejected” examples to meet user needs and deployed within a code service environment without the associated computational and latency costs of deploying a large generative model. While the techniques described herein refer specifically to Java code tasks such as unit test generation, the preference optimization framework is not limited to this specific code type and task and it should be understood that the preference alignment training framework may be used in other contexts to generate other types of responses as described herein (e.g., other programming languages such as Python, C++, RDML, etc. and/or other code task capabilities such as code generation, completion, explanation, documentation, etc.).

In various embodiments, the number of parameters in a generative model can range from hundreds of thousands of parameters to trillions of parameters. For the purposes of this disclosure, a large generative model such as a large LLM is defined as a generative model with substantially 100 billion parameters or more and a small generative model such as a small LLM is defined as an LLM with less than substantially 100 billion parameters. However, it should be understood that various other definitions of large and small generative models may be applicable without departing from the spirit and scope of the present disclosure so long as one of ordinary skill in the art would be able to determine the operational differences and/or limitations in models having said number of parameters (e.g., large being > or = to 250 billion parameters and small being <90 billion).

### Preference Data Curation and Synthesis

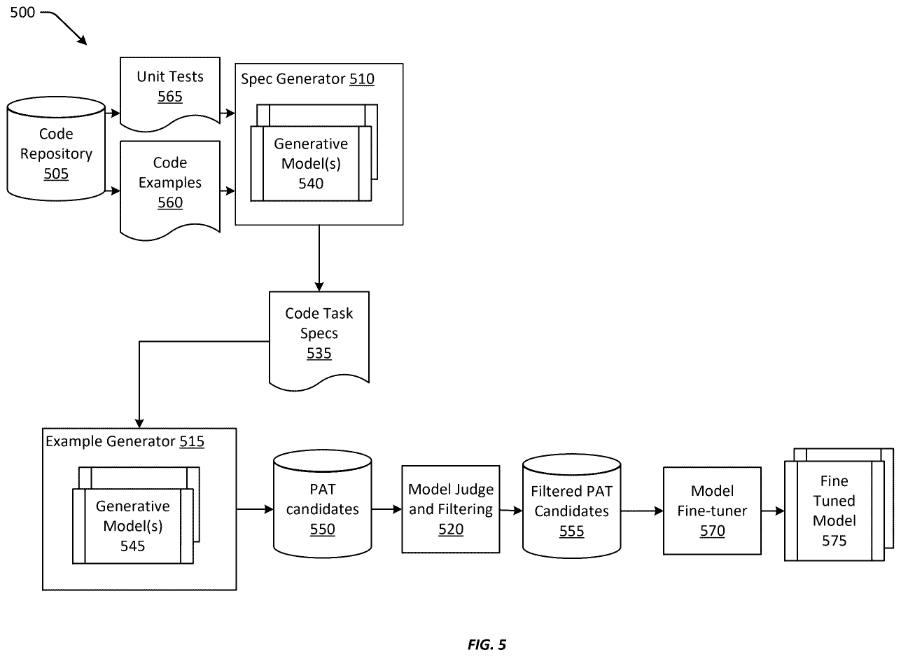

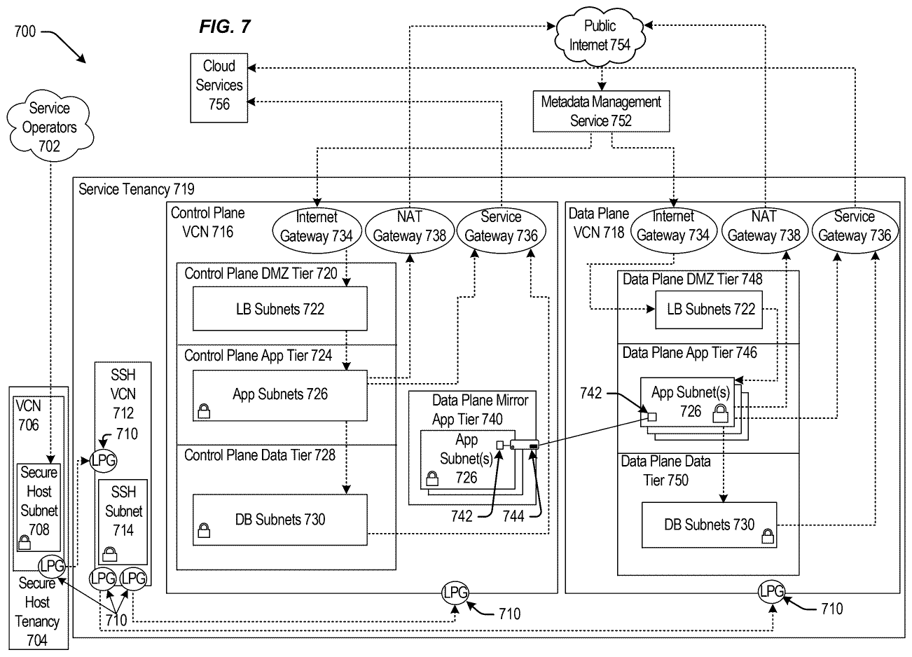

FIG. 5 is a simplified block diagram illustrating aspects of the preference alignment training framework 500 configured to synthesize preference data. The preference alignment training framework 500 can be implemented using software only, hardware only, firmware only, or any combination of hardware, software, and/or firmware. The synthetic preference data generated by the preference alignment training framework 500 can be used to fine-tune a code model included as part of a code agent system or code tool (e.g., code tool 104 from FIG. 1, code model 222 from FIG. 2). As depicted in FIG. 5, the preference alignment training framework 500 comprises subsystems, repositories, and models including but not limited to code repositories 505, spec generator subsystem 510, example generator subsystem 515, and model judge and filtering subsystem 520. Each subsystem can be understood to include an execution of one or more processes and/or programs implemented with software, hardware, and/or firmware within a system (e.g., as described with respect to FIGS. 7-11). Moreover, it should be understood that the one or more processes and/or programs can be executed as part of an iterative process that ultimately generates a set of synthetic examples. Iteration or an iterative process being the process of repeating a set of instructions or steps multiple times or cycles. For example, a set of instructions or steps may be executed for generating one or more synthetic examples and repeatedly executing the set of instructions or steps multiple times or over multiple cycles results in the generation of multiple synthetic examples (typically different synthetic examples), e.g., the set of synthetic examples. Each cycle of the set of instructions or steps may be executed serially, or multiple cycles of the set of instructions or steps may be executed in parallel.

The one or more code repositories 505 are a storage location where users such as software developers can keep and manage their source code and related files. The one or more code repositories 505 serve as a centralized platform for version control, collaboration, and code management, allowing multiple users to contribute to a project simultaneously while tracking changes, managing revisions, and resolving conflicts. The vast amount of code data can be utilized as bootstrapping to guide generators towards producing code task or skill examples that are relevant to user use cases for fine-tuning an existing or pre-trained generative model with user-specific code knowledge. As discussed in detail herein, the one or more code repositories 505 can be identified from internal sources or within one or more systems associated with a given enterprise (e.g., owned, operated, and/or used by a given enterprise). Code files are extracted from the code repositories 505. In some instances, the code files are extracted from the code repositories 505 based on a minimum successful build count (e.g., mbc>=x where x is a range of [1,5]). Table 2 below provides a summary of exemplary data that can be extracted from Java code repositories:

TABLE 2

| | | Unfiltered | Count w/ | Count w/ | Count w/ | Count w/ |
|---|---|---|---|---|---|---|
| | Data Source | Count | mbc >= 1 | mbc >= 2 | mbc >= 3 | mbc >= 5 |
| 1 | Java source codes | 1301280 | 734503 | 232808 | 150406 | 86179 |
| 2 | Java unit test source codes | 336620 | 190674 | 35384 | 11330 | 3486 |
| 3 | README.md files | 79274 | 43491 | 10025 | 3619 | 1166 |
| 4 | Other MD files | 160999 | 74727 | 33032 | 27423 | 463 |
| 5 | Java unit test pairs | 571339 | 166080 | 32374 | 9868 | 2832 |
| 6 | Java documentation pairs | 518802 | 279713 | 135429 | 115951 | 77024 |
| 7 | Python source codes | 387383 | 189182 | 22550 | 3698 | 1270 |

In some instances, the unit test pair code files are extracted by matching pattern, for example, of X.java with XTest.java, within the same code repository. This can help improve unit test generation capability of existing generative models. In some instances, code documentation pair files are extracted if more than 50% of the properties/attributes of the code, for example, classes/methods for Java code, are documented. A rule-based regex matching may be applied to estimate the documented properties/attributes (e.g., classes/methods). The code files for undocumented source code may then be acquired by removing all docs such as Javadocs from the documented version. In some instances, README files may be removed from the code files or ignored since they contain random notes which may not be useful for model training. As a result, the following data sources or code files can be extracted from the code repositories 505, leveraged and selected for use in the verticalization system and process: (i) source codes with raw code files (e.g., raw Java code files), (ii) unit test sources codes (e.g., Java unit test source codes) with, (iii) other types of related source codes (e.g., Python). Once the code files are extracted, they may be used to synthesize training data for fine tuning one or more pre-trained generative models on one or more code skills or tasks including those shown in Table 3.

TABLE 3

| | Java | |
|---|---|---|
| | Coding Task | Description |
| 1 | Unit Test | Input: existing functions from a given code snippet |
| | Generation | Output: unit test code |
| 2 | Code | Input: code snippet lacking documentation, |
| | Documen- | such as Javadocs |
| | tation | Output: code with documentation added |
| 3 | Code | Input: provided code snippet |
| | Explanation | Output: detailed explanation of the code in |
| | | natural language |
| 4 | Code Review | Input: existing code snippet, with or without a |
| | | diff (possibly from a PR request) |
| | | Output: code review that includes: |
| | | Identifying incorrect or inefficient code lines |
| | | Highlighting missing libraries |
| | | Detecting potential bugs in the code where |
| | | applicable |
| 5 | Code | Input: incomplete code with general or inline |
| | Completion | instructions |
| | | Output: completed code along with an explanation |

To combine developer expertise with the capabilities of artificial intelligence to generate high-quality synthetic preference data, initially spec generator subsystem 510 is used to generate detailed code task specifications 535 (e.g., Unit Test Specifications) from original programming code (e.g., Java code) in the code files extracted from the code repositories 505. The spec generator subsystem 510 comprises one or more generative models 540 (e.g., Cohere Command-R) trained to generate the code task specifications 535. The code task specifications 535 are then used to prompt one or more generative models 545 (e.g., Qwen2-72B-Instruct model) of the example generator subsystem 515 to improve the existing unit tests (e.g., human-written unit tests) in the code files extracted from the code repositories 505. This process forms the PAT candidates 550, including both the improved versions of the existing unit tests (enhanced unit tests) and the existing unit tests (original unit tests). To ensure the enhanced unit tests are of higher quality than the originals, comprehensive filtering steps that combine LLM-as-a-Judge evaluations and specific rules may then be applied using the model judge and filtering subsystem 520 to obtain filtered PAT candidates 555.

An exemplary detailed data curation pipeline for generating filtered PAT candidates 555 is described below:

Input: Code with corresponding Unit Tests. The initial input is example pairs comprised of code examples 560 (e.g., snippets of code) and corresponding unit tests 565. This is the real data coming from human developers with a wide variety of coding experience as described above with respect to the code repositories 505. Each example pair in the data includes the snippets of code (e.g., source code) for a single class and the corresponding unit tests, which may have been written by human developers.

Step 1: Unit Test Specs Generation. Research at Oracle Labs has demonstrated that instead of directly generating unit tests with a generative model such as an LLM, asking the LLM to follow a chain-of-thought approach to first create unit test specifications and define edge/corner cases significantly improves the quality of the generated unit tests. By covering more edge and corner cases, this technique enhances test robustness. The unit test specification is a detailed response or document outlining requirements and parameters needed to perform the code task such as unit test generation. In some instances, the unit test specification includes a statement of the initial state of the unit (individual units of code), the starting point of each test case, the inputs to the unit, including the value of any external data read by the unit, what the test case actually tests, in terms of the functionality of the unit, and the analysis used in the design of the test case (e.g., which decisions within the unit are tested). The specification may also include the expected outcome of the test case. The edge and corner case definitions include requirements for performance of the code task in scenarios that occur outside a normal or expected range of inputs, outputs, or behaviors of the code examples.

Inspired by this research, spec generator subsystem 510 is constructed to comprise one or more generative models 540 (e.g., Cohere Command-R) trained to generate the code task specifications 535 (e.g., unit test specifications and edge/corner case definitions) for code examples 560 (e.g., for a single Java class) aiming to improve the comprehensiveness of the corresponding unit tests 565. The prompt for spec generation may be constructed to include a set of examples of expected outputs (prompt_example.txt) and code example 560 for a given code class (e.g., Java class) as follows:
prompt_qn=“″”
Looking at the examples, generate JML specification for the code below, don't repeat the code, just include method signatures. Use title: “Spec-annotated-code”
Explain the specification in simple English for UNIT-TEST generation task (in point form). Use title: “Spec-in-English”
Please list ALL edge cases for the above program in detail with expected output for UNIT-TEST generation task (in point form). Use title: “Edge-cases”
“″”
promptfn= “prompt_example.txt” with open (promptfn) as fp:
prompt_example=fp.read( )
fname=“test.java” with open(fname) as fp:
code=fp.read( )
prompt=f″{prompt_example} \nQuestion: Code to be annotated: \n {code} \n {prompt_qn}”

To improve edge case coverage, the generative model is explicitly instructed to generate specification and define edge case requirements before a subsequent generative model is instructed to generate the unit test code. When tasked with defining examples of edge or corner cases for a given snippet of code and the expected output for a unit-test generation task, the generative model performs the task by first analyzing the code to understand its functionality, inputs, outputs, and constraints. This involves identifying logical structures like conditionals, loops, and error-handling mechanisms. The generative model evaluates the intended behavior of the code, including any assumptions and invariants, to identify points of potential failure or ambiguity. For example, if a function calculates a mathematical operation, the generative model will examine how it handles edge values like zero, negative numbers, or large inputs, ensuring that its behavior aligns with standard mathematical rules or documented requirements.

Next, the generative model systematically identifies edge and corner cases by focusing on scenarios that might challenge the robustness of the code. Edge cases often involve boundary values, such as minimum and maximum input sizes or limits of numerical ranges. Corner cases encompass less common scenarios, like invalid inputs, null values, or unusual data structures (e.g., empty arrays or strings). The generative model also considers environmental and contextual constraints, such as resource limitations or timing issues, if relevant to the code. Once these cases are identified, the generative model generates corresponding inputs and designs unit tests with expected outputs based on the intended behavior of the code. For example, it may predict that a function should raise an exception when given invalid inputs or return a specific value for boundary inputs.

Finally, the generative model defines the edge and corner case requirements in a structured format compatible with the relevant programming language and testing framework. Each of the edge and corner case definitions may include assertions to validate that the code behaves as expected under normal, edge, and corner conditions. For instance, the generative model might use Python's unit test library to create edge and corner case definitions that verify typical inputs, boundary conditions, and error scenarios. The generative model ensures the edge and corner case definitions are comprehensive and maintainable, covering all logical paths while being clear and reusable for developers. By iterating and refining the edge and corner case definitions or requirements, based on feedback or additional analysis, the generative model can ensure robust code validation.

Step 2: Unit Test Generation with Specs and Original Unit Tests. In this step, both the generated unit test specifications and edge/corner case definitions from Step 1 and the knowledge of the human developers (derived from human developed code examples and unit tests) are used to generate improved unit tests for the code examples 560. Specifically, starting with the unit tests 565, one or more generative models 545 (e.g., Qwen2-72B-Instruct and/or Llama-3.1-70B-Instruct) of the example generator subsystem 515 are asked to improve the unit tests 565 based on the generated code task specifications 535. The prompt for the one or more generative models 545 to improve the unit tests 565 may be constructed to include code example 560 for a given code class, the corresponding code task specification 535 (e.g., the unit test specification with edge/corner case definitions), and the corresponding unit test 565 as follows:

prompt=f″″″### Instruction
If you have been assigned a task to improve Java Unit tests, here's what you need to do:

### What You've Got:

+Java Class: This is the source code of the program that you're supposed to test.
+Specifications: These specify the rules your code should follow.
+Edge-cases: These are scenarios that may make your program behave unexpectedly.
+Human-Written Unit Tests: These are existing tests for the program developed by a fellow developer. Here's What You Should Do:
**Decode the Java Class**: Start by diving deep into the Java class. Understand its functionality and operations.
**Unravel the Specifications**: Pay close attention to the provided rules that the program should obey. Make sure your improved tests verify that these rules are being followed by the Java Class.
**Dismantle the Human-Written Unit Tests**: Analyze the existing tests created by another developer. If the tests are missing something or aren't following the rules precisely, think of a way to improve them. Discard any that are incorrect and eliminate any redundancies where necessary.
**Adapt the Human-Written Unit Tests**: Remember, you don't need to start from scratch. If the existing tests are useful, or can be modified slightly to meet specifications or check edge cases, edit and use them directly in your improved output.
**Conjure New Unit Tests**: If the current tests are insufficient for meeting the given Specifications, write new high-quality tests. These tests should ensure that every aspect of the Java Class behavior is tested, including edge-case scenarios.
The Objective: To ensure every single aspect of the program's functionality is correctly tested, make sure to revise the existing code and write new test cases when necessary. This way, you can be confident about the reliability of the Java Class.
**Strictly follow this**: Instead of partially copying or referring to the existing tests with sentences such as “//The test remains unchanged” or “//Additional . . . ”, your task is to write a complete, clear, and runnable version of them, incorporating all the necessary modifications and improvements.
###Java class
{code}

### ###Specifications

{spec}

### ###Edge-cases

{edge_cases}
###Human-written unit tests
{human_test}

In some instances, customization information may be included within the prompt. The customization information includes information about user requirements and expectations related to code task performance (e.g., task to be performed, preferred indentation style (spaces vs. tabs), naming conventions for variables and functions, commenting style, level of code abstraction, whether to use single or multiple return statements, placement of curly braces, the usage of specific coding patterns or libraries depending on the situation, etc.) in the form of instructions and examples of proper or improper responses for the code task such as unit test generation. Customization information may be generated (e.g., by a user or generated using a tool such as an LLM) based on known user preferences or patterns identified in code examples (e.g., code examples developed by a given user).

Instructions condense user requirements regarding code task performance, for example, the particular type of code involved in the task, the particular code task to be completed, explanation on format of response expected for the task, explanation of portions of the code to be used for the task, preferred code format, etc. As a particular example, a user may want to generate test units for existing functions from a given code snippet. Accordingly, instructions may include the type of code as being Java, the type of task as being test unit generation, the existing functions from a given code snippet, explanation on format of response or unit test code, etc.

The examples can be used as bootstrapping to guide the example generator subsystem 515 towards generating appropriate synthetic examples that are relevant to user use cases (e.g., unit tests). The code examples 560 can be portions of code (code snippets) obtained from the code files extracted from the code repositories 505. Preferably the code examples 560 are snippets of code that can be used by the example generator subsystem 515 to inspire the generation of synthetic examples for a specific code task. As an example, for the code task of unit test generation, the code examples 560 can include existing functions from a given code snippet. As another example, for the code task of code documentation, the code examples 560 can include code snippets lacking documentation, such as Javadocs. As another example, for the code task of code completion, the code examples 560 can include incomplete code with general or inline instructions.

The example generator subsystem 515 makes use of the one or more generative models 545 (e.g., LLMs) configured to generate appropriate synthetic examples with both instruction and response that are relevant to user use cases. The example generator subsystem 515 may access customization information to select a target code task for which a generative model is to be fine-tuned to perform. Each of the one or more generative models 545 generates synthetic examples corresponding to the target code task (e.g., unit test generation). Synthetic examples are generated using code example 560 for a given code class, the corresponding code task specification 535 (e.g., the unit test specification with edge/corner case definitions), and the corresponding unit test 565 as inspiration within the prompt generated by the example generator subsystem 515 and provided to the one or more generative models 545.

The prompts (see example above) can be generated by the example generator subsystem 515 using a structured approach such as templates and slot filling. A template serves as a pre-defined framework or skeleton, containing placeholders (or “slots”) where specific information (e.g., information from the customization information can be inserted dynamically. These slots represent variables or key elements that are tailored to the specific context or task at hand. For instance, in the above unit test generation task, the template could be designed as: What You've Got: +Java Class: This is the source code of the program that you're supposed to test. +Specifications: These specify the rules your code should follow. +Edge-cases: These are scenarios that may make your program behave unexpectedly. +Human-Written Unit Tests: These are existing tests for the program developed by a fellow developer. Followed by an explanation of What You Should Do. This section should be concise and completely self-contained, giving all the information needed to understand and address the problem. Slot filling involves populating the placeholders with relevant data, such as {spec}, {edge_cases}, {human_test}, and {code}. By combining a flexible template with targeted slot filling, prompts can be automatically generated in a consistent, accurate, and efficient manner. This method reduces the cognitive load of manually crafting prompts, ensures the inclusion of all required details, and enhances the precision of the generative model's response by providing it with clear, structured input.

Each of the one or more generative models 545 may process the prompt (e.g., code example 560 for a given code class, the corresponding code task specification 535, and the corresponding unit test 565) to generate a completion (Gold) for the associated prompt, which is the response (e.g., a new unit test for a code example) expected from executing the target code task using all or a portion of the original code example or all or a portion of an augmented version of the original code example. Each of the one or more generative models 545 may be considered a base generative model (e.g., Qwen2-72B-Instruct or Llama-3.1-70B-Instruct) trained to synthesize data by leveraging in-context learning with examples from the small set of data, e.g., human-generated data. The base generative model should be considered to be a small generative model such as a small LLM with less than substantially 100 billion parameters.

Step 3: PAT candidates (Updated Unit Tests vs Human Unit Tests). The PAT candidates 550 are constructed as triplets in the form of <x_prompt, y_c, y_r>:
x_prompt: The prompt for generating unit tests based on the code example 560 for a given code class, the corresponding code task specification 535, and the corresponding unit test 565.
y_c: the chosen (selected) unit tests corresponding to the code examples 560. Here the enhanced unit tests generate in Step 2 are used as the chosen ones.
y_r: the rejected unit tests corresponding to the code examples 560 (e.g., given source code). Here the original unit tests 565 are used as the rejected ones.

In some implementations, PAT candidates 550 may be generated by associating the prompt including instruction for the target code task with a completion (chosen unit test) and original unit test (rejected unit test) and storing the triplets and association in a data store, table and/or matrix as a dataset. In some implementations, PAT candidates 550 may be generated by labelling a prompt including instruction for the target code task and the original unit test as an input and labelling a corresponding completion as an output to create an input-output pair. Consequently, each synthetic example contains a prompt including instruction for the target code task, original unit test, and a corresponding completion. The dataset may be used for training a generative model as described with respect to FIG. 4. However, the dataset may contain noise related to errors or bad examples from the example generator subsystem 515. As such, the dataset comprised of the PAT candidates 550 may be referred to as a raw synthetic supervised fine-tuning (SFT) dataset and/or a raw distillation dataset.

Step 4: Filtering with LLM-as-a-Judge and rules. To ensure optimal performance of PAT candidates 550, the selected unit tests (y_c) may be confirmed to not only be of high quality but also superior to the rejected unit tests (y_r) for a given code example 560. Although chosen unit tests are designed to improve upon the original unit tests 565, they do not always achieve superior quality. To effectively filter out suboptimal PAT candidates 550, a set of criteria may be established to assess the quality of (y_c) and to determine whether it surpasses (y_r) as follows in Table 4.

TABLE 4

| | | Method |
|---|---|---|
| Criterion | Method | Type |
| Unit tests | Parse the unit tests using Tree-sitter. If this | Rule |
| should be | runs successfully without an error, the code is | |
| syntactically | syntactically correct | |
| correct. | | |
| All public | Extract all public methods from the input | Rule |
| methods of the | Java code using Tree-sitter and validate if the | |
| original Java | methods are being called in the unit tests | |
| code should be | | |
| covered by the | | |
| unit tests. | | |
| The unit tests | Extract all private methods from the input | Rule |
| should not | Java code using Tree-sitter and validate if | |
| include private | any method is being called in the unit tests | |
| methods, as | | |
| these are not | | |
| accessible from | | |
| outside the | | |
| Java class. | | |
| Unit tests | Use an LLM-as-a-Judge to validate whether | LLM |
| should be both | the unit tests are both semantically accurate | |
| semantically | and comprehensive | |
| accurate and | | |
| thorough. | | |

More specifically, in some implementations, the preference optimization framework 500 can include a model judge and filtering subsystem 520 to generate a filtered dataset comprised of filtered PAT candidates 555 that can be used for training a generative model or preferably for contrast revision to improve upon the unit test generation, as described in further detail below. In some instances, the example generator subsystem 515 may produce synthetic examples (PAT candidates) that are incorrect or irrelevant (e.g., contain noise related to errors or bad examples). The model judge and filtering subsystem 520 determines those examples that are incorrect or irrelevant using a generative model (e.g., LLM model) judge and/or filtering heuristics.

A generative model judge is a smaller generative model (e.g., less than 100 billion parameters such as Qwen2-72B-Instruct or Llama-3.1-70B-Instruct) used to evaluate the quality of another generative model's output (e.g., the synthetic examples output from the one or more generative models 545 of the example generator subsystem 515), essentially acting like a judge in a courtroom by assessing the results based on a different perspective. This approach aims to provide a more diverse and robust evaluation by combining another viewpoint of the generative model. Using a smaller generative model as a judge can be computationally cheaper than relying on a single large model or multiple models (e.g., juried of generative models). The generative model judge independently assesses a target generative model's (e.g., the one or more generative models 545 of the example generator subsystem 545) output based on specific criteria. The generative model judge may be trained on different data or have different strengths, leading to a wider range of evaluation criteria. The individual score or evaluation from the generative model is then compared to a predetermined threshold to arrive at a determination of whether synthetic examples are incorrect or irrelevant (e.g., if the final score is less than the predetermined threshold then an example is determined as incorrect or irrelevant). The synthetic examples that are determined by the generative model judge to be incorrect or irrelevant can then be removed from the dataset to arrive at a filtered set of synthetic examples—filtered PAT candidates 555—(comprising those synthetic examples determined by the generative model judge to be correct or relevant).

Filtering heuristics is a rule or method-based approach used to quickly filter out incorrect or irrelevant synthetic examples based on patterns or characteristics rather than exhaustive analysis. Essentially, it's a shortcut to identify likely synthetic examples candidates by looking for specific features that indicate relevance or quality based on filtering rules defined for each target code task and/or code syntax. The model judge and filtering subsystem 520 includes various types of filtering heuristics including, but not limited to, execution and/or prior knowledge-based rules such as semantic matching, hallucination-based filtering, actual code-based filtering, absence of code-based filtering, and the like (see example criteria in Table 4). In some instances, a combined set of multiple filtering steps may be performed on the synthetic examples (PAT candidates 550) from the dataset prior to or as an alternative to implementation of the generative model judge. In other instances, a combined set of multiple filtering steps may be performed on the filtered set of synthetic examples determined by the generative model judge to be correct or relevant.

In some instances, all or a subset of the filtering steps in the combined set of multiple filtering steps are applied to the synthetic examples. In other instances, only the filtering steps in the combined set of multiple filtering steps that are associated with the target code task are applied to the synthetic examples. In other instances, the combined set of multiple filtering steps only include filtering steps that are associated with the target code task and all or a subset of those filtering steps are applied to the synthetic examples. The synthetic examples that are determined by the filtering heuristics to be incorrect or irrelevant can then be removed from the dataset or the filtered set of synthetic examples determined by the generative model judge to be correct or relevant to arrive at the final data set (comprising those synthetic examples determined by the generative model judge and/or the filtering heuristics to be correct or relevant).

Incorrect or irrelevant examples are not included in the final data set comprised of the filtered PAT candidates 555 used for model training or for contrast revision to improve upon the unit test generation. In some instances, however, the incorrect or irrelevant examples can be provided to the example generator subsystem 515 as examples of prompt and completions that should not be generated by one or more generative models 545. An initial iteration of the data synthesis process may not include incorrect or irrelevant examples being used by the example generator subsystem 515, but subsequent iterations of the data synthesis process may include incorrect or irrelevant examples removed by the model judge and filtering subsystem 520 in a previous iteration. As an example, an initial model trained or fine-tuned using the final data set may not produce a desired accuracy for a user's use case. The data synthesis process may be performed again using incorrect or irrelevant examples generated during the initial run of the process to generate a new final data set to improve model accuracy for the user's use case.

Example of how the data set may be filtered:

To create the filtered PAT candidates 555, a filtering process executed by the model judge and filtering subsystem 520 can be used to ensure that the chosen unit tests (y_c) meet the required criteria and outperform the rejected unit tests (y_r). Specifically, the chosen unit tests (y_c) should achieve one or more of the following:
Pass one or more of the rule-based checks (e.g., all 3 rules described above).
Achieve a predetermined score (e.g., a score of 3 or more) from the LLM-as-a-Judge evaluation.
Have a higher LLM-as-a-Judge score than the rejected unit tests (y_r).
   This filtering process can be useful for ensuring a generative model (e.g., the smaller or base LLM) is trained under optimal conditions.

After obtaining a subset of rejected unit tests and selected unit tests (e.g., filtered PAT candidates 555) from example generator subsystem 515 and optionally the model judge and filtering subsystem 520, a final fine-tuning data set comprised of: PAT candidates 550, filtered PAT candidates 555, or any combination thereof is provided for model training or fine-tuning by the model fine-tuner 570. As discussed herein, the models being trained or fine-tuned may have a smaller number of parameters such as Qwen2-72B-Instruct or Llama-3.1-70B-Instruct. Preference optimization algorithms such as Proximal Policy Optimization (PPO), Direct Preference Optimization (DPO), and Odds Ratio Preference Optimization (ORPO) are applied by the model fine-tuner 570 to enhance the base model's performance using the “chosen” examples such as (y_c) and “rejected” examples such as (y_c) within the final fine-tuning data set. Advantageously, a generative model (e.g., the smaller or base LLM) can be trained or fine-tuned with the “chosen” and “rejected” examples to meet user needs and deployed within a code service environment without the associated computational and latency costs of deploying a large generative model.

Preference optimization algorithms are used to fine-tune the models by aligning their outputs with human preferences or desired behaviors (e.g., the preferences or desired behaviors derived from the final fine-tuning data set). These approaches leverage reinforcement learning or direct optimization to refine the model's responses based on feedback from human or synthetic evaluators. PPO uses a reward signal to iteratively adjust the model while ensuring stability and efficiency by constraining policy updates. DPO simplifies the process by directly optimizing the model's outputs against preference labels, bypassing the complexities of reward modeling. ORPO balances alignment with human preferences using odds ratios to optimize for both desired behavior and diversity in responses. Together, these methods enhance a model's ability to generate contextually appropriate, high-quality outputs tailored to specific tasks such as unit test generation or user expectations.

The model training or fine-tuning performed by the model fine-tuner 570 is described in detailed with respect to FIG. 4 and generates one or more fine-tuned machine learning models 575. A fine-tuned machine learning model refers to a pre-trained model (e.g., a pre-trained machine learning model or generically referred to herein in some instances as a machine learning model) that has been further trained or adapted to perform well on a specific task or domain (e.g., code generation, completion, explanation, documentation or unit test generation). The process typically involves taking a general-purpose model that has already been trained on a broad dataset and refining it using a smaller, task-specific dataset (e.g., the final fine-tuning data set). Fine-tuning can include adjusting the parameters of a pre-trained model by performing additional training using training examples (e.g., the final fine-tuning data set) for a specific task or domain such as code documentation. The qualities or characteristics that make a model fine-tuned may include: adjusted to address a particular problem, use case, or domain, retains the foundational knowledge learned during its initial pre-training while adapting to the specific task, fine-tuned model demonstrates better accuracy, relevance, or effectiveness in the specific task compared to the original pre-trained model, the model's outputs are tailored to the language, structure, or requirements of the specific domain or task, weights and biases (model parameters) of the model are updated during fine-tuning to optimize performance for the specific task, while avoiding overfitting to the smaller fine-tuning dataset, learn nuances specific to the task or field for which it is fine-tuned, or any combination thereof. The model fine-tuner 570 may fine-tune one or more generative models to generate the one or more fine-tuned machine learning models 575. Lastly, hyper-parameter tuning may be performed to select the model that performs best on the development data, which may be deployed in a production environment (e.g., code model 222 of FIG. 2 or code model 422 of FIG. 4).

### Illustrative Methods

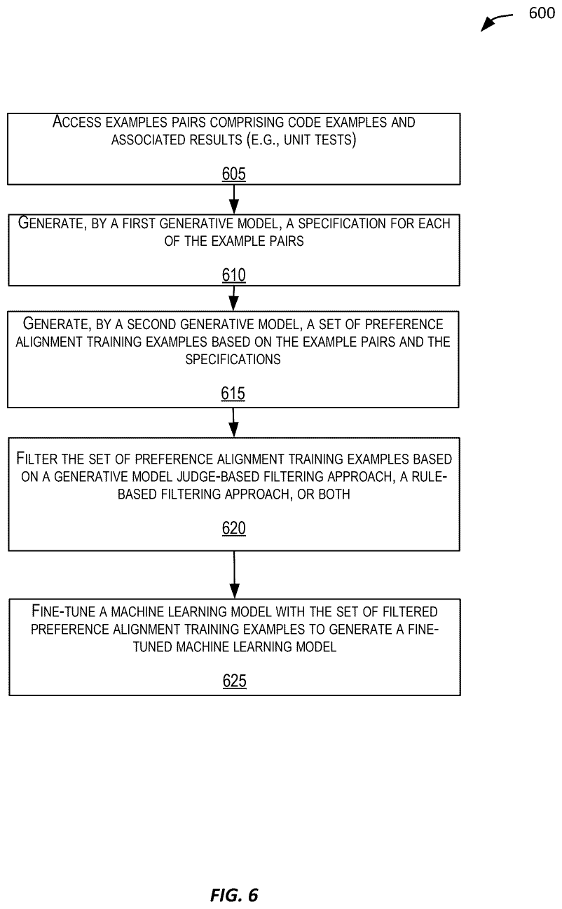

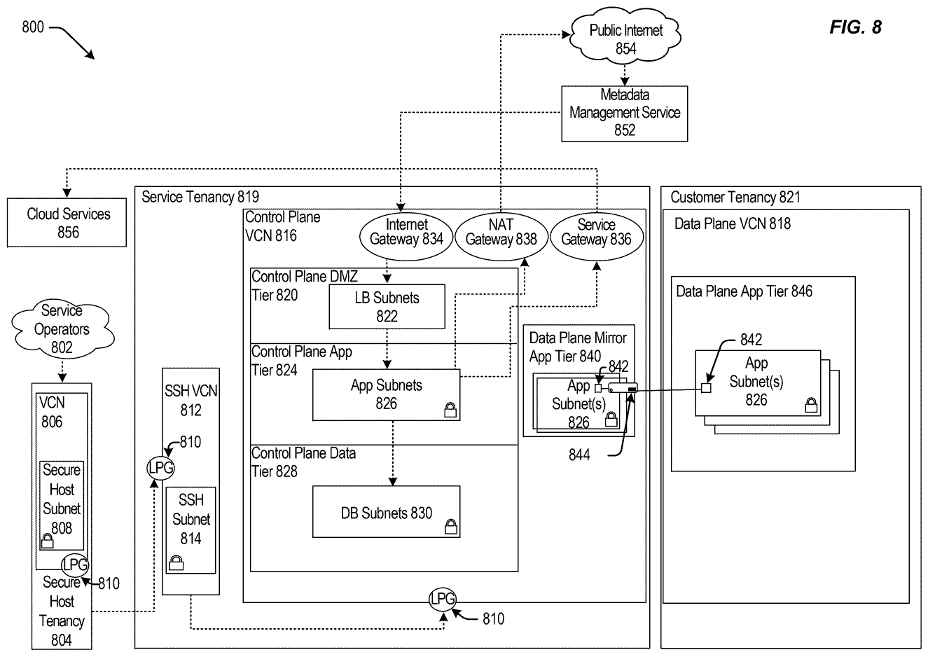

FIG. 6 is a flowchart illustrating a process 600 for generating a fine-tuning dataset including synthesizing training examples to train a machine learning model for performance of one or more code tasks, according to various embodiments. The processing depicted in FIG. 6 may be implemented in software (e.g., code, instructions, a program) executed by one or more processing units (e.g., one or more processors, cores) of the respective systems, hardware, or combinations thereof described throughout. The software may be stored on a non-transitory storage medium (e.g., on a memory device). Although the methods presented in FIG. 6 depict the various processing steps occurring in a particular sequence or order, this is not intended to be limiting. In certain alternative embodiments, the steps may be performed in parallel and/or in a different order. In certain embodiments, such as in the embodiments depicted in FIGS. 1-5, the processing depicted in FIG. 8 may be performed by framework 500, as described with respect to FIG. 5, and/or a training, testing, and deployment or production system or subsystem, as described with respect to FIGS. 1-4.

At step 605, example pairs comprising code examples and results (e.g., original unit tests) associated with performance of a code task such as unit test generation on corresponding code examples are accessed.

At step 610, a specification and edge and corner case definitions for each of the example pairs is generated, by a first generative model, based on the code examples and the results associated with the code examples. The specification is a response or document outlining requirements and parameters needed to perform the code task. The edge and corner case definitions include requirements for performance of the code task in scenarios that occur outside a normal or expected range of inputs, outputs, or behaviors of the code examples.

At step 615, a set of preference alignment training examples is generated, by a second generative model, based on the example pairs and the specification and the edge and corner case definitions for each of the example pairs. Each of the training examples in the set of preference alignment training examples comprises a version of a result (e.g., a new version of the original unit test, e.g., a “chosen” example) associated with a code example.

In some instances, generating the set of preference alignment training examples is an iterative process that comprises: generating, based on an example pair from the example pairs and the specification for the example pair, a training prompt comprising instructions requesting the second generative model to perform the code task using a code example from the example pair and insight derived from: (i) a result (e.g., original unit test) from the example pair and associated with the code example, and (ii) the specification for the example pair; generating, by the second generative model based on the training prompt, a training completion, which is a response expected from executing the code task using the code example (e.g., a new version of the original unit test, e.g., a “chosen” example); and associating the training prompt with the training completion and the result (e.g., original unit test-now termed “rejected” example) from the example pair to generate a preference alignment training example of the set of preference alignment training examples.

At step 620, the set of preference alignment training examples is filtered, by generative model judge-based filtering, rule-based filtering, or both, to generate a set of filtered preference alignment training examples.

In some instances, filtering the set of preference alignment training examples comprises performing the generative model judge-based filtering on the set of preference alignment training examples. The generative model judge-based filtering comprises evaluating, using a generative model, quality of each of the training examples in the set of preference alignment training examples and removing training examples from the set of preference alignment training examples based on the evaluating. In some instances, filtering the set of preference alignment training examples comprises performing the rule-based filtering on the set of preference alignment training examples. The rule-based filtering comprises evaluating, using filtering heuristics, quality of each of the training examples in the set of preference alignment training examples and removing training examples from the set of preference alignment training examples based on the evaluating. In some instances, filtering the set of preference alignment training examples comprises performing both the generative model judge-based filtering and the rule-based filtering.

In some instances, the filtering comprises: performing generative model judge-based filtering on the set of preference alignment training examples, wherein the generative model judge-based filtering comprises: evaluating, using a generative model, quality of each of the training examples in the set of preference alignment training examples, and evaluating, using the generative model, quality of each of the results associated with performance of the code task on corresponding code examples; performing rule-based filtering on the set of preference alignment training examples, wherein the rule-based filtering comprises evaluating, using filtering heuristics, quality of each of the training examples in the set of preference alignment training examples; and removing training examples from the set of preference alignment training examples based on: (i) the evaluating, by the generative model judge-based filtering, the quality of each of the training examples and the each of the results, (ii) the evaluating, by the rule-based filtering, the quality of each of the training examples, or (iii) both.

At step 625, a pre-trained machine learning model is fine-tuned with the set of filtered preference alignment training examples to generate a fine-tuned machine learning model. As discussed herein, the pre-trained machine learning model may have a smaller number of parameters such as Qwen2-72B-Instruct or Llama-3.1-70B-Instruct. Preference optimization algorithms such as PPO, DPO, and ORPO are applied in the fine-tuning to enhance performance of the pre-trained machine learning model using the version of the result (the “chosen” examples) and the original version of the result (the “rejected” examples) within the final fine-tuning data set. Advantageously, a generative model (e.g., the smaller or base LLM) can be trained or fine-tuned with the “chosen” and “rejected” examples to meet user needs and deployed within a code service environment without the associated computational and latency costs of deploying a large generative model

In some instances, the results are unit tests, the code task is a task for generating a unit test for given a code example, and a version of a result is a version of a unit test.

In some instances, generating the set of preference alignment training examples comprises generating, based on an example pair from the example pairs and the specification and the edge and corner case definitions for the example pair, a training prompt comprising instructions requesting the second generative model to perform the code task using a code example from the example pair and insight derived from: (i) a result from the example pair and associated with the code example, and (ii) the specification and the edge and corner case definitions for the example pair, and the training prompt is input into the second generative model to generate a training completion, which is a portion of a preference alignment training example of the set of preference alignment training examples.

In some instances, process 600 further comprises: receiving an input from a user, the input comprising a natural language component; converting the input into a prompt, wherein the prompt comprises an instruction, a code snippet associated with the natural language component, and an utterance associated with the natural language component, and wherein the utterance includes a request to perform the code task; transmitting the prompt to the fine-tuned machine learning model; receiving, from the fine-tuned machine learning model, a response corresponding to execution of the code task based at least in part on the prompt; and providing the response to the user.

### Illustrative System

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 7 is a block diagram 700 illustrating an example pattern of an IaaS architecture, according to at least one embodiment. Service operators 702 can be communicatively coupled to a secure host tenancy 704 that can include a virtual cloud network (VCN) 706 and a secure host subnet 708. In some examples, the service operators 702 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 706 and/or the Internet.

The VCN 706 can include a local peering gateway (LPG) 710 that can be communicatively coupled to a secure shell (SSH) VCN 712 via an LPG 710 contained in the SSH VCN 712. The SSH VCN 712 can include an SSH subnet 714, and the SSH VCN 712 can be communicatively coupled to a control plane VCN 716 via the LPG 710 contained in the control plane VCN 716. Also, the SSH VCN 712 can be communicatively coupled to a data plane VCN 718 via an LPG 710. The control plane VCN 716 and the data plane VCN 718 can be contained in a service tenancy 719 that can be owned and/or operated by the IaaS provider.

The control plane VCN 716 can include a control plane demilitarized zone (DMZ) tier 720 that acts as a perimeter network (e.g., portions of a corporate network between the corporate intranet and external networks). The DMZ-based servers may have restricted responsibilities and help keep breaches contained. Additionally, the DMZ tier 720 can include one or more load balancer (LB) subnet(s) 722, a control plane app tier 724 that can include app subnet(s) 726, a control plane data tier 728 that can include database (DB) subnet(s) 730 (e.g., frontend DB subnet(s) and/or backend DB subnet(s)). The LB subnet(s) 722 contained in the control plane DMZ tier 720 can be communicatively coupled to the app subnet(s) 726 contained in the control plane app tier 724 and an Internet gateway 734 that can be contained in the control plane VCN 716, and the app subnet(s) 726 can be communicatively coupled to the DB subnet(s) 730 contained in the control plane data tier 728 and a service gateway 736 and a network address translation (NAT) gateway 738. The control plane VCN 716 can include the service gateway 736 and the NAT gateway 738.

The control plane VCN 716 can include a data plane mirror app tier 740 that can include app subnet(s) 726. The app subnet(s) 726 contained in the data plane mirror app tier 740 can include a virtual network interface controller (VNIC) 742 that can execute a compute instance 744. The compute instance 744 can communicatively couple the app subnet(s) 726 of the data plane mirror app tier 740 to app subnet(s) 726 that can be contained in a data plane app tier 746.

The data plane VCN 718 can include the data plane app tier 746, a data plane DMZ tier 748, and a data plane data tier 750. The data plane DMZ tier 748 can include LB subnet(s) 722 that can be communicatively coupled to the app subnet(s) 726 of the data plane app tier 746 and the Internet gateway 734 of the data plane VCN 718. The app subnet(s) 726 can be communicatively coupled to the service gateway 736 of the data plane VCN 718 and the NAT gateway 738 of the data plane VCN 718. The data plane data tier 750 can also include the DB subnet(s) 730 that can be communicatively coupled to the app subnet(s) 726 of the data plane app tier 746.

The Internet gateway 734 of the control plane VCN 716 and of the data plane VCN 718 can be communicatively coupled to a metadata management service 752 that can be communicatively coupled to public Internet 754. Public Internet 754 can be communicatively coupled to the NAT gateway 738 of the control plane VCN 716 and of the data plane VCN 718. The service gateway 736 of the control plane VCN 716 and of the data plane VCN 718 can be communicatively coupled to cloud services 756.

In some examples, the service gateway 736 of the control plane VCN 716 or of the data plane VCN 718 can make application programming interface (API) calls to cloud services 756 without going through public Internet 754. The API calls to cloud services 756 from the service gateway 736 can be one-way: the service gateway 736 can make API calls to cloud services 756, and cloud services 756 can send requested data to the service gateway 736. But, cloud services 756 may not initiate API calls to the service gateway 736.

In some examples, the secure host tenancy 704 can be directly connected to the service tenancy 719, which may be otherwise isolated. The secure host subnet 708 can communicate with the SSH subnet 714 through an LPG 710 that may enable two-way communication over an otherwise isolated system. Connecting the secure host subnet 708 to the SSH subnet 714 may give the secure host subnet 708 access to other entities within the service tenancy 719.

The control plane VCN 716 may allow users of the service tenancy 719 to set up or otherwise provision desired resources. Desired resources provisioned in the control plane VCN 716 may be deployed or otherwise used in the data plane VCN 718. In some examples, the control plane VCN 716 can be isolated from the data plane VCN 718, and the data plane mirror app tier 740 of the control plane VCN 716 can communicate with the data plane app tier 746 of the data plane VCN 718 via VNICs 742 that can be contained in the data plane mirror app tier 740 and the data plane app tier 746.

In some examples, users of the system, or customers, can make requests, for example create, read, update, or delete (CRUD) operations, through public Internet 754 that can communicate the requests to the metadata management service 752. The metadata management service 752 can communicate the request to the control plane VCN 716 through the Internet gateway 734. The request can be received by the LB subnet(s) 722 contained in the control plane DMZ tier 720. The LB subnet(s) 722 may determine that the request is valid, and in response to this determination, the LB subnet(s) 722 can transmit the request to app subnet(s) 726 contained in the control plane app tier 724. If the request is validated and requires a call to public Internet 754, the call to public Internet 754 may be transmitted to the NAT gateway 738 that can make the call to public Internet 754. Metadata that may be desired to be stored by the request can be stored in the DB subnet(s) 730.

In some examples, the data plane mirror app tier 740 can facilitate direct communication between the control plane VCN 716 and the data plane VCN 718. For example, changes, updates, or other suitable modifications to configuration may be desired to be applied to the resources contained in the data plane VCN 718. Via a VNIC 742, the control plane VCN 716 can directly communicate with, and can thereby execute the changes, updates, or other suitable modifications to configuration to, resources contained in the data plane VCN 718.

In some embodiments, the control plane VCN 716 and the data plane VCN 718 can be contained in the service tenancy 719. In this case, the user, or the customer, of the system may not own or operate either the control plane VCN 716 or the data plane VCN 718. Instead, the IaaS provider may own or operate the control plane VCN 716 and the data plane VCN 718, both of which may be contained in the service tenancy 719. This embodiment can enable isolation of networks that may prevent users or customers from interacting with other users', or other customers', resources. Also, this embodiment may allow users or customers of the system to store databases privately without needing to rely on public Internet 754, which may not have a desired level of threat prevention, for storage.

In other embodiments, the LB subnet(s) 722 contained in the control plane VCN 716 can be configured to receive a signal from the service gateway 736. In this embodiment, the control plane VCN 716 and the data plane VCN 718 may be configured to be called by a customer of the IaaS provider without calling public Internet 754. Customers of the IaaS provider may desire this embodiment since database(s) that the customers use may be controlled by the IaaS provider and may be stored on the service tenancy 719, which may be isolated from public Internet 754.

FIG. 8 is a block diagram 800 illustrating another example pattern of an IaaS architecture, according to at least one embodiment. Service operators 802 (e.g., service operators 702 of FIG. 7) can be communicatively coupled to a secure host tenancy 804 (e.g., the secure host tenancy 704 of FIG. 7) that can include a virtual cloud network (VCN) 806 (e.g., the VCN 706 of FIG. 7) and a secure host subnet 808 (e.g., the secure host subnet 708 of FIG. 7). The VCN 806 can include a local peering gateway (LPG) 810 (e.g., the LPG 710 of FIG. 7) that can be communicatively coupled to a secure shell (SSH) VCN 812 (e.g., the SSH VCN 712 of FIG. 7) via an LPG 710 contained in the SSH VCN 812. The SSH VCN 812 can include an SSH subnet 814 (e.g., the SSH subnet 714 of FIG. 7), and the SSH VCN 812 can be communicatively coupled to a control plane VCN 816 (e.g., the control plane VCN 716 of FIG. 7) via an LPG 810 contained in the control plane VCN 816. The control plane VCN 816 can be contained in a service tenancy 819 (e.g., the service tenancy 719 of FIG. 7), and the data plane VCN 818 (e.g., the data plane VCN 718 of FIG. 7) can be contained in a customer tenancy 821 that may be owned or operated by users, or customers, of the system.

The control plane VCN 816 can include a control plane DMZ tier 820 (e.g., the control plane DMZ tier 720 of FIG. 7) that can include LB subnet(s) 822 (e.g., LB subnet(s) 722 of FIG. 7), a control plane app tier 824 (e.g., the control plane app tier 724 of FIG. 7) that can include app subnet(s) 826 (e.g., app subnet(s) 726 of FIG. 7), a control plane data tier 828 (e.g., the control plane data tier 728 of FIG. 7) that can include database (DB) subnet(s) 830 (e.g., similar to DB subnet(s) 730 of FIG. 7). The LB subnet(s) 822 contained in the control plane DMZ tier 820 can be communicatively coupled to the app subnet(s) 826 contained in the control plane app tier 824 and an Internet gateway 834 (e.g., the Internet gateway 734 of FIG. 7) that can be contained in the control plane VCN 816, and the app subnet(s) 826 can be communicatively coupled to the DB subnet(s) 830 contained in the control plane data tier 828 and a service gateway 836 (e.g., the service gateway 736 of FIG. 7) and a network address translation (NAT) gateway 838 (e.g., the NAT gateway 738 of FIG. 7). The control plane VCN 816 can include the service gateway 836 and the NAT gateway 838.

The control plane VCN 816 can include a data plane mirror app tier 840 (e.g., the data plane mirror app tier 740 of FIG. 7) that can include app subnet(s) 826. The app subnet(s) 826 contained in the data plane mirror app tier 840 can include a virtual network interface controller (VNIC) 842 (e.g., the VNIC of 742) that can execute a compute instance 844 (e.g., similar to the compute instance 744 of FIG. 7). The compute instance 844 can facilitate communication between the app subnet(s) 826 of the data plane mirror app tier 840 and the app subnet(s) 826 that can be contained in a data plane app tier 846 (e.g., the data plane app tier 746 of FIG. 7) via the VNIC 842 contained in the data plane mirror app tier 840 and the VNIC 842 contained in the data plane app tier 846.

The Internet gateway 834 contained in the control plane VCN 816 can be communicatively coupled to a metadata management service 852 (e.g., the metadata management service 752 of FIG. 7) that can be communicatively coupled to public Internet 854 (e.g., public Internet 754 of FIG. 7). Public Internet 854 can be communicatively coupled to the NAT gateway 838 contained in the control plane VCN 816. The service gateway 836 contained in the control plane VCN 816 can be communicatively coupled to cloud services 856 (e.g., cloud services 756 of FIG. 7).

In some examples, the data plane VCN 818 can be contained in the customer tenancy 821. In this case, the IaaS provider may provide the control plane VCN 816 for each customer, and the IaaS provider may, for each customer, set up a unique compute instance 844 that is contained in the service tenancy 819. Each compute instance 844 may allow communication between the control plane VCN 816, contained in the service tenancy 819, and the data plane VCN 818 that is contained in the customer tenancy 821. The compute instance 844 may allow resources, that are provisioned in the control plane VCN 816 that is contained in the service tenancy 819, to be deployed or otherwise used in the data plane VCN 818 that is contained in the customer tenancy 821.

In other examples, the customer of the IaaS provider may have databases that live in the customer tenancy 821. In this example, the control plane VCN 816 can include the data plane mirror app tier 840 that can include app subnet(s) 826. The data plane mirror app tier 840 can reside in the data plane VCN 818, but the data plane mirror app tier 840 may not live in the data plane VCN 818. That is, the data plane mirror app tier 840 may have access to the customer tenancy 821, but the data plane mirror app tier 840 may not exist in the data plane VCN 818 or be owned or operated by the customer of the IaaS provider. The data plane mirror app tier 840 may be configured to make calls to the data plane VCN 818 but may not be configured to make calls to any entity contained in the control plane VCN 816. The customer may desire to deploy or otherwise use resources in the data plane VCN 818 that are provisioned in the control plane VCN 816, and the data plane mirror app tier 840 can facilitate the desired deployment, or other usage of resources, of the customer.

In some embodiments, the customer of the IaaS provider can apply filters to the data plane VCN 818. In this embodiment, the customer can determine what the data plane VCN 818 can access, and the customer may restrict access to public Internet 854 from the data plane VCN 818. The IaaS provider may not be able to apply filters or otherwise control access of the data plane VCN 818 to any outside networks or databases. Applying filters and controls by the customer onto the data plane VCN 818, contained in the customer tenancy 821, can help isolate the data plane VCN 818 from other customers and from public Internet 854.

In some embodiments, cloud services 856 can be called by the service gateway 836 to access services that may not exist on public Internet 854, on the control plane VCN 816, or on the data plane VCN 818. The connection between cloud services 856 and the control plane VCN 816 or the data plane VCN 818 may not be live or continuous. Cloud services 856 may exist on a different network owned or operated by the IaaS provider. Cloud services 856 may be configured to receive calls from the service gateway 836 and may be configured to not receive calls from public Internet 854. Some cloud services 856 may be isolated from other cloud services 856, and the control plane VCN 816 may be isolated from cloud services 856 that may not be in the same region as the control plane VCN 816. For example, the control plane VCN 816 may be located in “Region 1,” and cloud service “Deployment 7,” may be located in Region 1 and in “Region 2.” If a call to Deployment 7 is made by the service gateway 836 contained in the control plane VCN 816 located in Region 1, the call may be transmitted to Deployment 7 in Region 1. In this example, the control plane VCN 816, or Deployment 7 in Region 1, may not be communicatively coupled to, or otherwise in communication with, Deployment 7 in Region 2.

FIG. 9 is a block diagram 900 illustrating another example pattern of an IaaS architecture, according to at least one embodiment. Service operators 902 (e.g., service operators 702 of FIG. 7) can be communicatively coupled to a secure host tenancy 904 (e.g., the secure host tenancy 704 of FIG. 7) that can include a virtual cloud network (VCN) 906 (e.g., the VCN 706 of FIG. 7) and a secure host subnet 908 (e.g., the secure host subnet 708 of FIG. 7). The VCN 906 can include an LPG 910 (e.g., the LPG 710 of FIG. 7) that can be communicatively coupled to an SSH VCN 912 (e.g., the SSH VCN 712 of FIG. 7) via an LPG 910 contained in the SSH VCN 912. The SSH VCN 912 can include an SSH subnet 914 (e.g., the SSH subnet 714 of FIG. 7), and the SSH VCN 912 can be communicatively coupled to a control plane VCN 916 (e.g., the control plane VCN 716 of FIG. 7) via an LPG 910 contained in the control plane VCN 916 and to a data plane VCN 918 (e.g., the data plane 718 of FIG. 7) via an LPG 910 contained in the data plane VCN 918. The control plane VCN 916 and the data plane VCN 918 can be contained in a service tenancy 919 (e.g., the service tenancy 719 of FIG. 7).

The control plane VCN 916 can include a control plane DMZ tier 920 (e.g., the control plane DMZ tier 720 of FIG. 7) that can include load balancer (LB) subnet(s) 922 (e.g., LB subnet(s) 722 of FIG. 7), a control plane app tier 924 (e.g., the control plane app tier 724 of FIG. 7) that can include app subnet(s) 926 (e.g., similar to app subnet(s) 726 of FIG. 7), a control plane data tier 928 (e.g., the control plane data tier 728 of FIG. 7) that can include DB subnet(s) 930. The LB subnet(s) 922 contained in the control plane DMZ tier 920 can be communicatively coupled to the app subnet(s) 926 contained in the control plane app tier 924 and to an Internet gateway 934 (e.g., the Internet gateway 734 of FIG. 7) that can be contained in the control plane VCN 916, and the app subnet(s) 926 can be communicatively coupled to the DB subnet(s) 930 contained in the control plane data tier 928 and to a service gateway 936 (e.g., the service gateway of FIG. 7) and a network address translation (NAT) gateway 938 (e.g., the NAT gateway 738 of FIG. 7). The control plane VCN 916 can include the service gateway 936 and the NAT gateway 938.

The data plane VCN 918 can include a data plane app tier 946 (e.g., the data plane app tier 746 of FIG. 7), a data plane DMZ tier 948 (e.g., the data plane DMZ tier 748 of FIG. 7), and a data plane data tier 950 (e.g., the data plane data tier 750 of FIG. 7). The data plane DMZ tier 948 can include LB subnet(s) 922 that can be communicatively coupled to trusted app subnet(s) 960 and untrusted app subnet(s) 962 of the data plane app tier 946 and the Internet gateway 934 contained in the data plane VCN 918. The trusted app subnet(s) 960 can be communicatively coupled to the service gateway 936 contained in the data plane VCN 918, the NAT gateway 938 contained in the data plane VCN 918, and DB subnet(s) 930 contained in the data plane data tier 950. The untrusted app subnet(s) 962 can be communicatively coupled to the service gateway 936 contained in the data plane VCN 918 and DB subnet(s) 930 contained in the data plane data tier 950. The data plane data tier 950 can include DB subnet(s) 930 that can be communicatively coupled to the service gateway 936 contained in the data plane VCN 918.

The untrusted app subnet(s) 962 can include one or more primary VNICs 964(1)-(N) that can be communicatively coupled to tenant virtual machines (VMs) 966(1)-(N). Each tenant VM 966(1)-(N) can be communicatively coupled to a respective app subnet 967(1)-(N) that can be contained in respective container egress VCNs 968(1)-(N) that can be contained in respective customer tenancies 970(1)-(N). Respective secondary VNICs 972(1)-(N) can facilitate communication between the untrusted app subnet(s) 962 contained in the data plane VCN 918 and the app subnet contained in the container egress VCNs 968(1)-(N). Each container egress VCNs 968(1)-(N) can include a NAT gateway 938 that can be communicatively coupled to public Internet 954 (e.g., public Internet 754 of FIG. 7).

The Internet gateway 934 contained in the control plane VCN 916 and contained in the data plane VCN 918 can be communicatively coupled to a metadata management service 952 (e.g., the metadata management system 752 of FIG. 7) that can be communicatively coupled to public Internet 954. Public Internet 954 can be communicatively coupled to the NAT gateway 938 contained in the control plane VCN 916 and contained in the data plane VCN 918. The service gateway 936 contained in the control plane VCN 916 and contained in the data plane VCN 918 can be communicatively coupled to cloud services 956.

In some embodiments, the data plane VCN 918 can be integrated with customer tenancies 970. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 946. Code to run the function may be executed in the VMs 966(1)-(N), and the code may not be configured to run anywhere else on the data plane VCN 918. Each VM 966(1)-(N) may be connected to one customer tenancy 970. Respective containers 971(1)-(N) contained in the VMs 966(1)-(N) may be configured to run the code. In this case, there can be a dual isolation (e.g., the containers 971(1)-(N) running code, where the containers 971(1)-(N) may be contained in at least the VM 966(1)-(N) that are contained in the untrusted app subnet(s) 962), which may help prevent incorrect or otherwise undesirable code from damaging the network of the IaaS provider or from damaging a network of a different customer. The containers 971(1)-(N) may be communicatively coupled to the customer tenancy 970 and may be configured to transmit or receive data from the customer tenancy 970. The containers 971(1)-(N) may not be configured to transmit or receive data from any other entity in the data plane VCN 918. Upon completion of running the code, the IaaS provider may kill or otherwise dispose of the containers 971(1)-(N).

In some embodiments, the trusted app subnet(s) 960 may run code that may be owned or operated by the IaaS provider. In this embodiment, the trusted app subnet(s) 960 may be communicatively coupled to the DB subnet(s) 930 and be configured to execute CRUD operations in the DB subnet(s) 930. The untrusted app subnet(s) 962 may be communicatively coupled to the DB subnet(s) 930, but in this embodiment, the untrusted app subnet(s) may be configured to execute read operations in the DB subnet(s) 930. The containers 971(1)-(N) that can be contained in the VM 966(1)-(N) of each customer and that may run code from the customer may not be communicatively coupled with the DB subnet(s) 930.

In other embodiments, the control plane VCN 916 and the data plane VCN 918 may not be directly communicatively coupled. In this embodiment, there may be no direct communication between the control plane VCN 916 and the data plane VCN 918. However, communication can occur indirectly through at least one method. An LPG 910 may be established by the IaaS provider that can facilitate communication between the control plane VCN 916 and the data plane VCN 918. In another example, the control plane VCN 916 or the data plane VCN 918 can make a call to cloud services 956 via the service gateway 936. For example, a call to cloud services 956 from the control plane VCN 916 can include a request for a service that can communicate with the data plane VCN 918.

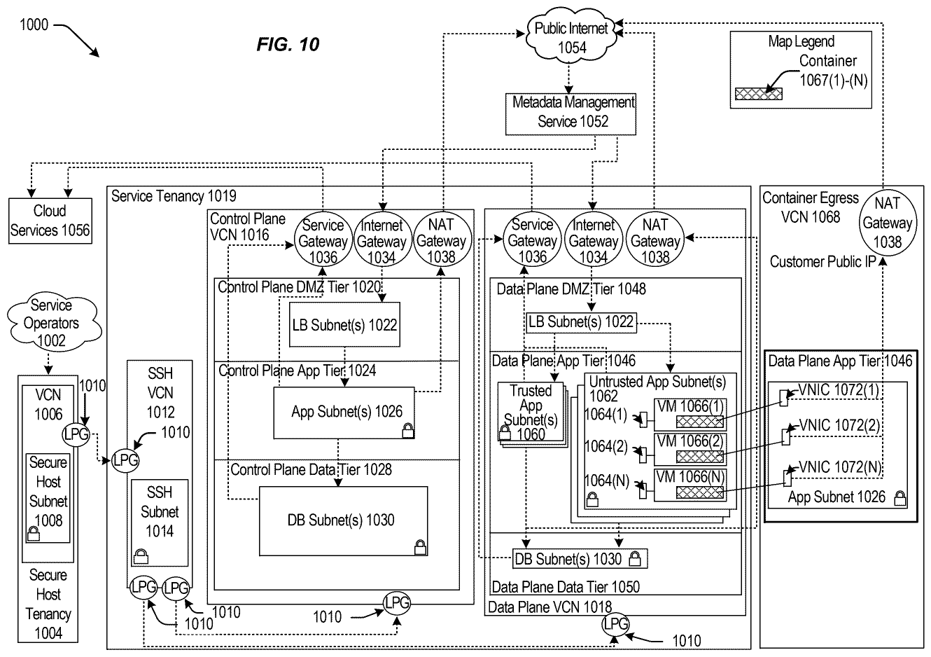

FIG. 10 is a block diagram 1000 illustrating another example pattern of an IaaS architecture, according to at least one embodiment. Service operators 1002 (e.g., service operators 702 of FIG. 7) can be communicatively coupled to a secure host tenancy 1004 (e.g., the secure host tenancy 704 of FIG. 7) that can include a virtual cloud network (VCN) 1006 (e.g., the VCN 706 of FIG. 7) and a secure host subnet 1008 (e.g., the secure host subnet 708 of FIG. 7). The VCN 1006 can include an LPG 1010 (e.g., the LPG 710 of FIG. 7) that can be communicatively coupled to an SSH VCN 1012 (e.g., the SSH VCN 712 of FIG. 7) via an LPG 1010 contained in the SSH VCN 1012. The SSH VCN 1012 can include an SSH subnet 1014 (e.g., the SSH subnet 714 of FIG. 7), and the SSH VCN 1012 can be communicatively coupled to a control plane VCN 1016 (e.g., the control plane VCN 716 of FIG. 7) via an LPG 1010 contained in the control plane VCN 1016 and to a data plane VCN 1018 (e.g., the data plane 718 of FIG. 7) via an LPG 1010 contained in the data plane VCN 1018. The control plane VCN 1016 and the data plane VCN 1018 can be contained in a service tenancy 1019 (e.g., the service tenancy 719 of FIG. 7).

The control plane VCN 1016 can include a control plane DMZ tier 1020 (e.g., the control plane DMZ tier 720 of FIG. 7) that can include LB subnet(s) 1022 (e.g., LB subnet(s) 722 of FIG. 7), a control plane app tier 1024 (e.g., the control plane app tier 724 of FIG. 7) that can include app subnet(s) 1026 (e.g., app subnet(s) 726 of FIG. 7), a control plane data tier 1028 (e.g., the control plane data tier 728 of FIG. 7) that can include DB subnet(s) 1030 (e.g., DB subnet(s) 930 of FIG. 9). The LB subnet(s) 1022 contained in the control plane DMZ tier 1020 can be communicatively coupled to the app subnet(s) 1026 contained in the control plane app tier 1024 and to an Internet gateway 1034 (e.g., the Internet gateway 734 of FIG. 7) that can be contained in the control plane VCN 1016, and the app subnet(s) 1026 can be communicatively coupled to the DB subnet(s) 1030 contained in the control plane data tier 1028 and to a service gateway 1036 (e.g., the service gateway of FIG. 7) and a network address translation (NAT) gateway 1038 (e.g., the NAT gateway 738 of FIG. 7). The control plane VCN 1016 can include the service gateway 1036 and the NAT gateway 1038.

The data plane VCN 1018 can include a data plane app tier 1046 (e.g., the data plane app tier 746 of FIG. 7), a data plane DMZ tier 1048 (e.g., the data plane DMZ tier 748 of FIG. 7), and a data plane data tier 1050 (e.g., the data plane data tier 750 of FIG. 7). The data plane DMZ tier 1048 can include LB subnet(s) 1022 that can be communicatively coupled to trusted app subnet(s) 1060 (e.g., trusted app subnet(s) 960 of FIG. 9) and untrusted app subnet(s) 1062 (e.g., untrusted app subnet(s) 962 of FIG. 9) of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include primary VNICs 1064(1)-(N) that can be communicatively coupled to tenant virtual machines (VMs) 1066(1)-(N) residing within the untrusted app subnet(s) 1062. Each tenant VM 1066(1)-(N) can run code in a respective container 1067(1)-(N), and be communicatively coupled to an app subnet 1026 that can be contained in a data plane app tier 1046 that can be contained in a container egress VCN 1068. Respective secondary VNICs 1072(1)-(N) can facilitate communication between the untrusted app subnet(s) 1062 contained in the data plane VCN 1018 and the app subnet contained in the container egress VCN 1068. The container egress VCN can include a NAT gateway 1038 that can be communicatively coupled to public Internet 1054 (e.g., public Internet 754 of FIG. 7).

The Internet gateway 1034 contained in the control plane VCN 1016 and contained in the data plane VCN 1018 can be communicatively coupled to a metadata management service 1052 (e.g., the metadata management system 752 of FIG. 7) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively coupled to cloud services 1056.

In some examples, the pattern illustrated by the architecture of block diagram 1000 of FIG. 10 may be considered an exception to the pattern illustrated by the architecture of block diagram 900 of FIG. 9 and may be desirable for a customer of the IaaS provider if the IaaS provider cannot directly communicate with the customer (e.g., a disconnected region). The respective containers 1067(1)-(N) that are contained in the VMs 1066(1)-(N) for each customer can be accessed in real-time by the customer. The containers 1067(1)-(N) may be configured to make calls to respective secondary VNICs 1072(1)-(N) contained in app subnet(s) 1026 of the data plane app tier 1046 that can be contained in the container egress VCN 1068. The secondary VNICs 1072(1)-(N) can transmit the calls to the NAT gateway 1038 that may transmit the calls to public Internet 1054. In this example, the containers 1067(1)-(N) that can be accessed in real-time by the customer can be isolated from the control plane VCN 1016 and can be isolated from other entities contained in the data plane VCN 1018. The containers 1067(1)-(N) may also be isolated from resources from other customers.

In other examples, the customer can use the containers 1067(1)-(N) to call cloud services 1056. In this example, the customer may run code in the containers 1067(1)-(N) that requests a service from cloud services 1056. The containers 1067(1)-(N) can transmit this request to the secondary VNICs 1072(1)-(N) that can transmit the request to the NAT gateway that can transmit the request to public Internet 1054. Public Internet 1054 can transmit the request to LB subnet(s) 1022 contained in the control plane VCN 1016 via the Internet gateway 1034. In response to determining the request is valid, the LB subnet(s) can transmit the request to app subnet(s) 1026 that can transmit the request to cloud services 1056 via the service gateway 1036.

It should be appreciated that IaaS architectures 700, 800, 900, 1000 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

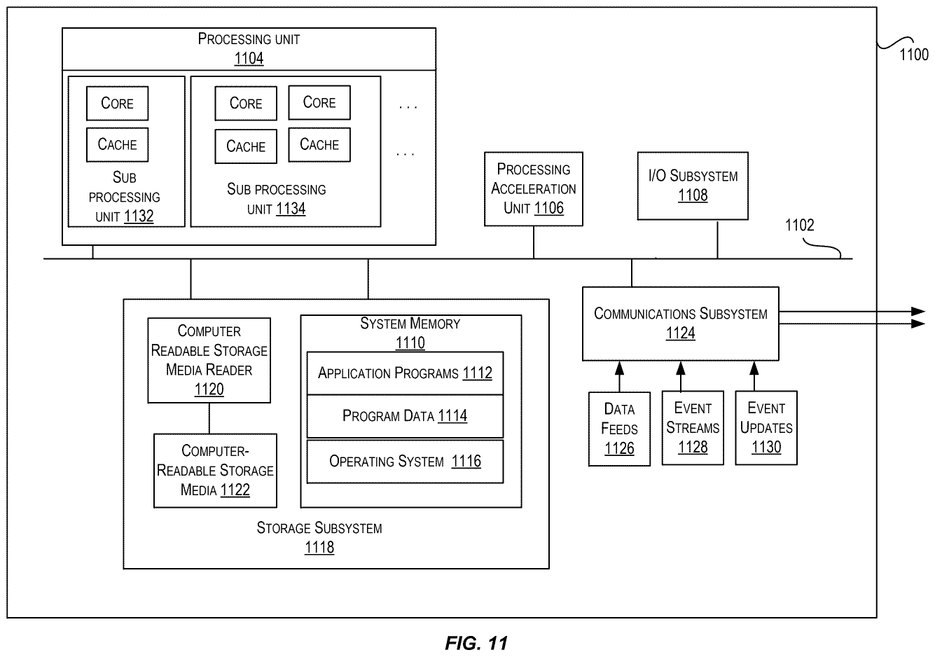

FIG. 11 illustrates an example computer system 1100, in which various embodiments may be implemented. The system 1100 may be used to implement any of the computer systems described above. As shown in the figure, computer system 1100 includes a processing unit 1104 that communicates with a number of peripheral subsystems via a bus subsystem 1102. These peripheral subsystems may include a processing acceleration unit 1106, an I/O subsystem 1108, a storage subsystem 1118 and a communications subsystem 1124. Storage subsystem 1118 includes tangible computer-readable storage media 1122 and a system memory 1110.

Bus subsystem 1102 provides a mechanism for letting the various components and subsystems of computer system 1100 communicate with each other as intended. Although bus subsystem 1102 is shown schematically as a single bus, alternative embodiments of the bus subsystem may utilize multiple buses. Bus subsystem 1102 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1104, which can be implemented as one or more integrated circuits (e.g., a conventional microprocessor or microcontroller), controls the operation of computer system 1100. One or more processors may be included in processing unit 1104. These processors may include single core or multicore processors. In certain embodiments, processing unit 1104 may be implemented as one or more independent processing units 1132 and/or 1134 with single or multicore processors included in each processing unit. In other embodiments, processing unit 1104 may also be implemented as a quad-core processing unit formed by integrating two dual-core processors into a single chip.

In various embodiments, processing unit 1104 can execute a variety of programs in response to program code and can maintain multiple concurrently executing programs or processes. At any given time, some or all of the program code to be executed can be resident in processor(s) 1104 and/or in storage subsystem 1118. Through suitable programming, processor(s) 1104 can provide various functionalities described above. Computer system 1100 may additionally include a processing acceleration unit 1106, which can include a digital signal processor (DSP), a special-purpose processor, and/or the like.

I/O subsystem 1108 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1100 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1100 may comprise a storage subsystem 1118 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1104 provide the functionality described above. Storage subsystem 1118 may also provide a repository for storing data used in accordance with the present disclosure.

As depicted in the example in FIG. 11, storage subsystem 1118 can include various components including a system memory 1110, computer-readable storage media 1122, and a computer readable storage media reader 1120. System memory 1110 may store program instructions that are loadable and executable by processing unit 1104. System memory 1110 may also store data that is used during the execution of the instructions and/or data that is generated during the execution of the program instructions. Various different kinds of programs may be loaded into system memory 1110 including but not limited to client applications, Web browsers, mid-tier applications, relational database management systems (RDBMS), virtual machines, containers, etc.

System memory 1110 may also store an operating system 1116. Examples of operating system 1116 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1100 executes one or more virtual machines, the virtual machines along with their guest operating systems (GOSs) may be loaded into system memory 1110 and executed by one or more processors or cores of processing unit 1104.

System memory 1110 can come in different configurations depending upon the type of computer system 1100. For example, system memory 1110 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1110 may include a basic input/output system (BIOS) containing basic routines that help to transfer information between elements within computer system 1100, such as during start-up.

Computer-readable storage media 1122 may represent remote, local, fixed, and/or removable storage devices plus storage media for temporarily and/or more permanently containing, storing, computer-readable information for use by computer system 1100 including instructions executable by processing unit 1104 of computer system 1100.

Computer-readable storage media 1122 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1122 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1122 may include, but is not limited to, Zip® drives, flash memory cards, universal serial bus (USB) flash drives, secure digital (SD) cards, DVD disks, digital video tape, and the like. Computer-readable storage media 1122 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1100.

Machine-readable instructions executable by one or more processors or cores of processing unit 1104 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1124 provides an interface to other computer systems and networks. Communications subsystem 1124 serves as an interface for receiving data from and transmitting data to other systems from computer system 1100. For example, communications subsystem 1124 may enable computer system 1100 to connect to one or more devices via the Internet. In some embodiments communications subsystem 1124 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1124 can provide wired network connectivity (e.g., Ethernet) in addition to or instead of a wireless interface.

In some embodiments, communications subsystem 1124 may also receive input communication in the form of structured and/or unstructured data feeds 1126, event streams 1128, event updates 1130, and the like on behalf of one or more users who may use computer system 1100.

By way of example, communications subsystem 1124 may be configured to receive data feeds 1126 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1124 may also be configured to receive data in the form of continuous data streams, which may include event streams 1128 of real-time events and/or event updates 1130, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1124 may also be configured to output the structured and/or unstructured data feeds 1126, event streams 1128, event updates 1130, and the like to one or more databases that may be in communication with one or more streaming data source computers coupled to computer system 1100.

Computer system 1100 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1100 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method comprising accessing example pairs comprising code examples and results associated with performance of a code task on corresponding code examples;
generating, by a first generative model, a specification and edge and corner case definitions for each of the example pairs based on the code examples and the results associated with the code examples, wherein the specification is a response or document outlining requirements and parameters needed to perform the code task, and the edge and corner case definitions include requirements for performance of the code task in scenarios that occur outside a normal or expected range of inputs, outputs, or behaviors of the code examples;
generating, by a second generative model, a set of preference alignment training examples based on the example pairs and the specification and the edge and corner case definitions for each of the example pairs, wherein each of the training examples in the set of preference alignment training examples comprises a version of a result associated with a code example; and
fine-tuning a pre-trained machine learning model with the set of preference alignment training examples to generate a fine-tuned machine learning model.

2. The computer-implemented method of claim 1, further comprising, prior to fine-tuning the pre-trained machine learning model, filtering the set of preference alignment training examples to generate a set of filtered preference alignment training examples, wherein the filtering comprises:
performing generative model judge-based filtering on the set of preference alignment training examples, wherein the generative model judge-based filtering comprises evaluating, using a generative model, quality of each of the training examples in the set of preference alignment training examples and removing training examples from the set of preference alignment training examples based on the evaluating,
performing rule-based filtering on the set of preference alignment training examples, wherein the rule-based filtering comprises evaluating, using filtering heuristics, quality of each of the training examples in the set of preference alignment training examples and removing training examples from the set of preference alignment training examples based on the evaluating, or
performing both the generative model judge-based filtering and the rule-based filtering, wherein the set of filtered preference alignment training examples is used for fine-tuning the pre-trained machine learning model as an alternative to fine-tuning using the set of preference alignment training examples.

3. The computer-implemented method of claim 1, wherein generating the set of preference alignment training examples is an iterative process that comprises:
generating, based on an example pair from the example pairs and the specification and the edge and corner case definitions for the example pair, a training prompt comprising instructions requesting the second generative model to perform the code task using a code example from the example pair and insight derived from: (i) a result from the example pair and associated with the code example, and (ii) the specification and the edge and corner case definitions for the example pair,
generating, by the second generative model based on the training prompt, a training completion, which is a response expected from executing the code task using the code example, and
associating the training prompt with the training completion and the result from the example pair to generate a preference alignment training example of the set of preference alignment training examples.

4. The computer-implemented method of claim 1, wherein the results are unit tests, the code task is a task for generating a unit test for given a code example, and a version of a result is a version of a unit test.

5. The computer-implemented method of claim 1, wherein:
generating the set of preference alignment training examples comprises generating, based on an example pair from the example pairs and the specification and the edge and corner case definitions for the example pair, a training prompt comprising instructions requesting the second generative model to perform the code task using a code example from the example pair and insight derived from: (i) a result from the example pair and associated with the code example, and (ii) the specification and the edge and corner case definitions for the example pair, and
the training prompt is input into the second generative model to generate a training completion, which is a portion of a preference alignment training example of the set of preference alignment training examples.

6. The computer-implemented method of claim 1, further comprising, prior to fine-tuning the pre-trained machine learning model, filtering the set of preference alignment training examples to generate a set of filtered preference alignment training examples, wherein the filtering comprises:
performing generative model judge-based filtering on the set of preference alignment training examples, wherein the generative model judge-based filtering comprises:
evaluating, using a generative model, quality of each of the training examples in the set of preference alignment training examples, and
evaluating, using the generative model, quality of each of the results associated with performance of the code task on corresponding code examples;
performing rule-based filtering on the set of preference alignment training examples, wherein the rule-based filtering comprises evaluating, using filtering heuristics, quality of each of the training examples in the set of preference alignment training examples; and
removing training examples from the set of preference alignment training examples based on: (i) the evaluating, by the generative model judge-based filtering, the quality of each of the training examples and the each of the results, (ii) the evaluating, by the rule-based filtering, the quality of each of the training examples, or (iii) both,
wherein the set of filtered preference alignment training examples is used for fine-tuning the pre-trained machine learning model as an alternative to fine-tuning using the set of preference alignment training examples.

7. The computer-implemented method of claim 1, further comprising:
receiving an input from a user, the input comprising a natural language component;
converting the input into a prompt, wherein the prompt comprises an instruction, a code snippet associated with the natural language component, and an utterance associated with the natural language component, and wherein the utterance includes a request to perform the code task;
transmitting the prompt to the fine-tuned machine learning model;
receiving, from the fine-tuned machine learning model, a response corresponding to execution of the code task based at least in part on the prompt; and
providing the response to the user.

8. A system comprising:
one or more processors; and
one or more computer-readable media storing instructions which, when executed by the one or more processors, cause the system to perform operations comprising:
accessing example pairs comprising code examples and results associated with performance of a code task on corresponding code examples;
generating, by a first generative model, a specification and edge and corner case definitions for each of the example pairs based on the code examples and the results associated with the code examples;
generating, by a second generative model, a set of preference alignment training examples based on the example pairs and the specification and the edge and corner case definitions for each of the example pairs, wherein each of the training examples in the set of preference alignment training examples comprises a version of a result associated with a code example;
filtering, by generative model judge-based filtering, rule-based filtering, or both, the set of preference alignment training examples to generate a set of filtered preference alignment training examples; and
fine-tuning a supervised fine-tuned generative model with the set of filtered preference alignment training examples to generate a fine-tuned generative model, wherein the fine-tuning comprises applying one or more preference optimization algorithms to enhance performance of the supervised fine-tuned generative model using the version of the result and the result within each filtered preference alignment training example of the set of filtered preference alignment training example.

9. The system of claim 8, wherein the filtering comprises:
performing the generative model judge-based filtering on the set of preference alignment training examples, wherein the generative model judge-based filtering comprises evaluating, using a generative model, quality of each of the training examples in the set of preference alignment training examples and removing training examples from the set of preference alignment training examples based on the evaluating,
performing the rule-based filtering on the set of preference alignment training examples, wherein the rule-based filtering comprises evaluating, using filtering heuristics, quality of each of the training examples in the set of preference alignment training examples and removing training examples from the set of preference alignment training examples based on the evaluating, or
performing both the generative model judge-based filtering and the rule-based filtering.

10. The system of claim 8, wherein generating the set of preference alignment training examples is an iterative process that comprises:
generating, based on an example pair from the example pairs and the specification and the edge and corner case definitions for the example pair, a training prompt comprising instructions requesting the second generative model to perform the code task using a code example from the example pair and insight derived from: (i) a result from the example pair and associated with the code example, and (ii) the specification and the edge and corner case definitions for the example pair,
generating, by the second generative model based on the training prompt, a training completion, which is a response expected from executing the code task using the code example, and
associating the training prompt with the training completion and the result from the example pair to generate a preference alignment training example of the set of preference alignment training examples.

11. The system of claim 8, wherein the results are unit tests, the code task is a task for generating a unit test for given a code example, and a version of a result is a version of a unit test.

12. The system of claim 8, wherein:
generating the set of preference alignment training examples comprises generating, based on an example pair from the example pairs and the specification and the edge and corner case definitions for the example pair, a training prompt comprising instructions requesting the second generative model to perform the code task using a code example from the example pair and insight derived from: (i) a result from the example pair and associated with the code example, and (ii) the specification and the edge and corner case definitions for the example pair, and
the training prompt is input into the second generative model to generate a training completion, which is a portion of a preference alignment training example of the set of preference alignment training examples.

13. The system of claim 8, wherein the filtering comprises:
performing generative model judge-based filtering on the set of preference alignment training examples, wherein the generative model judge-based filtering comprises:
evaluating, using a generative model, quality of each of the training examples in the set of preference alignment training examples, and
evaluating, using the generative model, quality of each of the results associated with performance of the code task on corresponding code examples;
performing rule-based filtering on the set of preference alignment training examples, wherein the rule-based filtering comprises evaluating, using filtering heuristics, quality of each of the training examples in the set of preference alignment training examples; and
removing training examples from the set of preference alignment training examples based on: (i) the evaluating, by the generative model judge-based filtering, the quality of each of the training examples and the each of the results, (ii) the evaluating, by the rule-based filtering, the quality of each of the training examples, or (iii) both,
wherein the set of filtered preference alignment training examples is used for fine-tuning the pre-trained machine learning model as an alternative to fine-tuning using the set of preference alignment training examples.

14. The system of claim 8, wherein the operations further comprise:
receiving an input from a user, the input comprising a natural language component;
converting the input into a prompt, wherein the prompt comprises an instruction, a code snippet associated with the natural language component, and an utterance associated with the natural language component, and wherein the utterance includes a request to perform the code task;
transmitting the prompt to the fine-tuned machine learning model;
receiving, from the fine-tuned machine learning model, a response corresponding to execution of the code task based at least in part on the prompt; and
providing the response to the user.

15. One or more non-transitory computer-readable media storing instructions which, when executed by one or more processors, cause the one or more processors to perform operations comprising:
accessing example pairs comprising code examples and unit tests associated with performance of a code task on corresponding code examples;
generating, by a first generative model, a specification and edge and corner case definitions for each of the example pairs based on the code examples and the results associated with the code examples, wherein the specification is a response or document outlining requirements and parameters needed to perform the code task, and the edge and corner case definitions include requirements for performance of the code task in scenarios that occur outside a normal or expected range of inputs, outputs, or behaviors of the code examples;
generating, by a second generative model, a set of preference alignment training examples based on the example pairs and the specification and the edge and corner case definitions for each of the example pairs, wherein each of the training examples in the set of preference alignment training examples comprises a version of a unit test associated with a code example; and
fine-tuning a pre-trained machine learning model with the set of preference alignment training examples to generate a fine-tuned machine learning model, wherein the fine-tuning comprises applying one or more preference optimization algorithms to enhance performance of the pre-trained machine learning model using the version of the unit test and the unit test within each revised preference alignment training example of the set of preference alignment training examples.

16. The one or more non-transitory computer-readable media of claim 15, wherein the operations further comprise, prior to revising the set of preference alignment training examples, filtering the set of preference alignment training examples to generate a set of filtered preference alignment training examples, wherein the filtering comprises:
performing generative model judge-based filtering on the set of preference alignment training examples, wherein the generative model judge-based filtering comprises evaluating, using a generative model, quality of each of the training examples in the set of preference alignment training examples and removing training examples from the set of preference alignment training examples based on the evaluating,
performing rule-based filtering on the set of preference alignment training examples, wherein the rule-based filtering comprises evaluating, using filtering heuristics, quality of each of the training examples in the set of preference alignment training examples and removing training examples from the set of preference alignment training examples based on the evaluating, or
performing both the generative model judge-based filtering and the rule-based filtering,
wherein the set of filtered preference alignment training examples used for fine-tuning the pre-trained machine learning model as an alternative to fine-tuning using the set of preference alignment training examples.

17. The one or more non-transitory computer-readable media of claim 15, wherein generating the set of preference alignment training examples is an iterative process that comprises:
generating, based on an example pair from the example pairs and the specification and the edge and corner case definitions for the example pair, a training prompt comprising instructions requesting the second generative model to perform the code task using a code example from the example pair and insight derived from: (i) a unit test from the example pair and associated with the code example, and (ii) the specification and the edge and corner case definitions for the example pair,
generating, by the second generative model based on the training prompt, a training completion, which is a response expected from executing the code task using the code example, and
associating the training prompt with the training completion and the unit test from the example pair to generate a preference alignment training example of the set of preference alignment training examples.

18. The one or more non-transitory computer-readable media of claim 15, wherein:
generating the set of preference alignment training examples comprises generating, based on an example pair from the example pairs and the specification and the edge and corner case definitions for the example pair, a training prompt comprising instructions requesting the second generative model to perform the code task using a code example from the example pair and insight derived from: (i) a unit test from the example pair and associated with the code example, and (ii) the specification and the edge and corner case definitions for the example pair, and
the training prompt is input into the second generative model to generate a training completion, which is a portion of a preference alignment training example of the set of preference alignment training examples.

19. The one or more non-transitory computer-readable media of claim 15, wherein the operations further comprise, prior to fine-tuning the pre-trained machine learning model, filtering the set of preference alignment training examples to generate a set of filtered preference alignment training examples, wherein the filtering comprises:
performing generative model judge-based filtering on the set of preference alignment training examples, wherein the generative model judge-based filtering comprises:
evaluating, using a generative model, quality of each of the training examples in the set of preference alignment training examples, and
evaluating, using the generative model, quality of each of the results associated with performance of the code task on corresponding code examples;
performing rule-based filtering on the set of preference alignment training examples, wherein the rule-based filtering comprises evaluating, using filtering heuristics, quality of each of the training examples in the set of preference alignment training examples; and
removing training examples from the set of preference alignment training examples based on: (i) the evaluating, by the generative model judge-based filtering, the quality of each of the training examples and the each of the results, (ii) the evaluating, by the rule-based filtering, the quality of each of the training examples, or (iii) both,
wherein the set of filtered preference alignment training examples is used for fine-tuning the pre-trained machine learning model as an alternative to fine-tuning using the set of preference alignment training examples.

20. The one or more non-transitory computer-readable media of claim 15, wherein the operations further comprise:
receiving an input from a user, the input comprising a natural language component;
converting the input into a prompt, wherein the prompt comprises an instruction, a code snippet associated with the natural language component, and an utterance associated with the natural language component, and wherein the utterance includes a request to perform the code task;
transmitting the prompt to the fine-tuned machine learning model;
receiving, from the fine-tuned machine learning model, a response corresponding to execution of the code task based at least in part on the prompt; and
providing the response to the user.
